(19) United States
(12) Patent Application Publication
(10) Pub. No.: US 2002/0046091 A1
(43) Pub. Date: Apr. 18, 2002

(54) Interactive incentive marketing system

(76) Inventors: Robert Mooers, Newport Beach, CA (US); Wendy Topf Miller, Aliso Viejo, CA (US); James Parker, Long Beach, CA (US); Richard Schriever, Costa Mesa, CA (US); Larry Ortiz, Buena Park, CA (US)

Correspondence Address: Thomas J. Finn, Esq., Snell & Wilmer L.L.P., One Arizona Center, 400 E. Van Buren, Phoenix, AZ, 85004-2202, US

(21) Appl. No.: 09/758,748

(22) Filed: Jan. 11, 2001

Related U.S. Application Data
(60) Provisional application No. 60/175,544, filed on Jan. 11, 2000.

(51) Int. Cl. G06F 17/60

(52) U.S. Cl. 705/14

(57) ABSTRACT

A system and method for facilitating an online, web-based, interactive incentive marketing program is disclosed. An incentive marketing program is made available online to subscribing companies, employees, and vendors, where all parties have password protected access to incentive program features and all parties have restricted access to various parts of the program according to defined user profiles, subscriber roles (e.g., sales manager or sales representative), and permissions. All parties or users are able to input and retrieve varying amounts of data according to their user permissions. The program tracks User reported sales information and presents this information to an approval process to determine if sale is valid. Once sale is approved, incentive points are automatically awarded and the user is able to redeem those points for merchandise. To redeem points, a user selects a product from an online catalog and purchases the product. The interconnectivity of this system further provides enhanced communication and program flexibility.

### CROSS REFERENCE TO RELATED APPLICATIONS

This application claims priority to, and the benefit of, provisional application Ser. No. 60/175,544, filed Jan. 11, 2000, which is hereby incorporated by reference.

### FIELD OF THE INVENTION

The present invention generally relates to a system for managing, tracking, and facilitating incentive and award fulfillment programs. More specifically, the present invention utilizes the interconnectivity of a networked system, e.g., the internet, and a unique incentive marketing web-based program to establish a unique communication medium among the incentive marketing company, a subscribing company, the subscribing company employees, and merchandise vendors in order to better manage and utilize incentive and award fulfillment programs; and to better facilitate efficient and effective one-to-one incentive marketing strategies between the subscribing company and its target public.

### BACKGROUND OF THE INVENTION

Companies engaged in the production, distribution and/or selling of merchandise or services continually seek ways to generate more sales and improve the productivity and performance of their production or sales force. As a way to increase productivity and performance, these companies often offer incentives or rewards to their employees for selling product or for meeting and exceeding sales or production goals. For example, if a sales representative of a company sells a product, he or she may be awarded incentive points for selling that product. The sales representative accumulates incentive points by the continuing sales of the employer-company's product or line of product. At some point in time, the sales representative is rewarded for his or her efforts by being allowed to redeem the incentive points for a “prize” (e.g., merchandise or a travel package). Traditionally, the sales representative would select the prize from a merchandise catalog where the prizes are listed according to point value. Because companies engaged in the production or sales of goods or services often do not have the resources to manage incentive programs, they have typically outsourced these programs to companies specializing in incentive programs and services.

The typical incentive program described above often has three components commonly referred to in the industry as (1) incentive marketing, (2) reward fulfillment, and (3) communications. First, the process of incentive marketing entails tailoring an incentive program for a company that motivates its employees (e.g. sales representatives) to work harder to sell more product and generate more revenue. Second, reward fulfillment, in the context noted above, is a component of the incentive marketing program in that once an employee has accumulated incentive points, these points are redeemed through the fulfillment process, that is, the incentive points are redeemed for a prize, i.e., merchandise or travel packages. The act of fulfilling the employees redemption order is referred to as fulfillment. The entire process of incentive marketing and reward fulfillment is often handled by two different entities, an incentive marketing company and a merchandise fulfillment house. Finally, the communication component, which is often the most neglected—but important—component involves keeping the subscribing company's target public (e.g., its employees) aware of the incentive program and actively involved.

The traditional approach to incentive marketing in the business-to-employee or business-to-business setting has been very static and non-reactive to market influences. Existing programs have been ill-equipped to modify behaviors to compensate for changes in product cost structures, wholesaler discounts, manufacturer rebates, etc. These programs have also failed to adequately address the third component above in that employees may not even be aware of an incentive program, and even if they are aware, may not be actively involved. Additionally, in the traditional approach to incentive marketing, because of the high cost of publication and distribution, the merchandise catalog that the employee refers to when redeeming incentive points for prizes is typically published only once every 12-18 months. Because the traditional catalog defined the incentive point values for product sales, the types of product being sold, the merchandize (prizes) available for redemption, and also the redemption point value for a given prize; the incentive marketing program was not easily modified or changed to accommodate changes in market trends or market forces. For example, the catalog may list the sale of Widget A as earning 50 incentive points for the representative and may set the redemption value of a gift pen set at 40 incentive points. A sales representative selling Widget A would earn and bank 50 incentive points and would later be able to redeem those points for a prize (e.g., a gift pen set costing 40 points). If the catalog listed the sale of Widget B as earning 10 incentive points for the representative, the sales representative may very well concentrate his sales efforts on Widget A—widget A sales being worth five times as much as widget B sales.

These point values may be well for the company at the start of the incentive program if, for instance, the profit margin for Widget A was better than that for Widget B. However, what if 3 months into an incentive program, the profit margins for Widget B exceeded that of Widget A? It would be then desirable for the company to adjust the incentive program parameters to reflect the changes in market forces so that the sales representatives refocus their efforts to selling Widget B. These types of incentive adjustments are difficult with traditional systems. With traditional systems, for the entire 12-18 months the incentive point values are fixed (i.e., the given point value assigned to a given product can not change), the types of merchandise or travel rewards are fixed (i.e., no changes to the types of reward available), the vendors utilized for the rewards are fixed, and the employees often lose interest because of lack of a communication. Because of this inflexible approach to incentive marketing and reward fulfillment, businesses have not been able to adjust the incentive program structure to meet real world demands and to efficiently motivate change in employee behavior according to changes in product cost structures, product supply and demand or other relevant market forces. More importantly, businesses have not been able to keep their target public (e.g., employees) informed and involved.

The advent of the internet continues to revolutionize the incentive industry and other related industries. Computerized incentive programs utilizing the internet for transmission of data, tracking, and reporting are becoming known in the art. Recently developed internet-based programs directed to incentive marketing have solved some of the above problems of traditional incentive marketing and fulfillment systems (see, e.g., U.S. Pat. No. 6,061,660, issued to Eggelston et al.). However, these programs have been primarily directed to Business-to-consumer incentive marketing issues. There remains a need for an integrated and interactive business-to-business or business-to-employee incentive program.

### SUMMARY OF THE INVENTION

The present invention solves the above problems through a system that interconnects the incentive program manager (incentive company), the subscribing company or employer (subscriber), the subscriber's employees (employee), and award fulfillment vendors (vendor) via the internet (or similar computer networked system) to provide a fully automated, integrated, and interactive incentive program and award fulfillment service.

The disclosed invention permits the subscriber's website to be seamlessly linked to the incentive company's website so as to appear transparent to the employee, where all levels of employees (e.g., sales representatives, managers, supervisors, etc) and the subscriber have password protected unlimited access to the incentive program. The employees are provided with program explanation, rules and regulations; continuously updated information on the subscriber's new products and services; educational information and quizzes about subscriber's line of products and services; individualized personal sales data by product/service; limited-time award redemption opportunities; tracking of individual incentive points, a rewards catalog; and reward redemption online processing and email confirmation. The sales managers and representatives of the subscriber are provided with password protected information relating to real-time area/region and individual dealer unit and dollar sales performance reports; additional or supplemental incentive program rules, regulations, and standings; and, access to the merchandise catalog. Vendors of the employer-client are also provided with password access to the incentive program data, such as product unit sales by client and sales representative, current company news, notification of those who have taken the vendor's on-line educational quizzes, and notification of those who have signed up for a vendor-sponsored trip or event.

The incentive marketing program is also configured to track, measure, update and process claims so as to ensure that the program participants are continually advised and made aware of various developments with the incentive program. The present invention facilitates better business practices by providing a proactive incentive program that adjusts in a real-time manner to changes in the marketplace, such as changes in cost structure, manufacturing discounts, product supply and demand, and other market forces that would be known to those skilled in incentive marketing and product fulfillment.

### BRIEF DESCRIPTION OF THE DRAWINGS

Additional aspects of the present invention will become evident upon reviewing the non-limiting embodiments described in the specification and the claims taken in conjunction with the accompanying figures, wherein like reference numerals denote like elements.

FIG. 1 is a schematic diagram of an exemplary network structure for the present invention.

FIG. 2 is a schematic diagram of exemplary information storage databases and components of the present invention.

FIGS. 3-6 are flowcharts of an exemplary basic login and sign-up processes of the present invention

FIGS. 7-12 are flowcharts of exemplary system processes of the present invention that relate to addition, deletion and modification of user data.

FIGS. 13-17 are flowcharts of exemplary system processes of the present invention that relate to user functions, roles and permissions.

FIGS. 18-22 are flowcharts of exemplary system processes of the present invention that relate to sales reporting and sales approval.

FIGS. 23-27 are flowcharts of exemplary system processes of the present invention that relate to award redemption and online shopping.

FIGS. 28-30 are screen shots of exemplary web pages of the present invention showing the tabs and processes for configuring a specific web site look and feel (theme).

FIGS. 31-35 are screen shots of exemplary web pages of the present invention depicting tabs and processes for the sales reporting and approving process.

FIGS. 36-39 are screen shots of exemplary web pages of the present invention depicting user profile, role, and permission information.

FIG. 40 is a screen shot of an exemplary web page of the present invention depicting an introduction after registration sign-up.

### DETAILED DESCRIPTION OF EXEMPLARY EMBODIMENTS

The present invention is directed to an interactive incentive marketing system that enables businesses to tailor their incentive programs to specific business needs and to adjust the incentive programs to changes in market environments. In general, one embodiment of this system permits a sales representative to log onto a web site to report sale or other event transaction immediately upon completion of the sale or transaction. The web-based incentive marketing computer application maintains and tracks sales data, product information, purchasing trends, etc. As the sales are reported and approved by the sales manager, the sales representative accumulates incentive points. These incentive points are redeemable at any time online through the incentive marketing application web page. To redeem points, a sales representative logs onto a website, accesses the incentive marketing application web page, and simply selects a product from an online virtual catalog of merchandise. All information, including product sales, point redemptions, and much more can be tracked and maintained in a database for retrieval by the subscribing business. This allows the subscribing business to adjust incentive program parameters frequently to more effectively motivate employees and influence behaviors, thereby increasing employee performance. Moreover, through targeted reporting and push-down communications (e.g., email) to the subscribing business's target public (e.g., sales representatives), the subscribing business is able to generate interest in the incentive program, keep all parties informed and better operate the incentive program.

Although the invention has been described herein as an interactive incentive marketing system for business-to-business or business-to-consumer application, one of ordinary skill in the art will appreciate that the invention is not so limited (e.g., may be used as a consumer-based incentive program) and includes any interactive incentive marketing system providing real-time reporting, validation and redemption features not found in the prior art. Furthermore, it should be understood that the detailed description and specific examples, while indicating exemplary embodiments of the present invention, are given for purposes of illustration only and not for limitation. Although the present invention described herein principally details exemplary online transactions, it should be appreciated that this system is not so limited and would accommodate offline transactions as well.

Additionally, the present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. For a basic introduction of cryptography, please review a text written by Bruce Schneider which is entitled “Applied Cryptography: Protocols, Algorithms, And Source Code In C,” published by John Wiley & Sons (second edition, 1996), which is hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Communication between the parties to the transaction and the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, deencryption, compression, decompression, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The incentive marketing company, its subscribing companies, vendors and other participants to the system of the present invention may represent individual people, entities, or business. It is further noted that other participants may be involved in some phases of the transaction, but these participants are not shown.

Each participant is typically equipped with a computing system to facilitate online incentive marketing and fulfillment transactions. The participant may have a computing unit in the form of a personal computer, although other types of computing units may be used including laptops, notebooks, hand held computers, set-top boxes, and the like. The incentive company has a computing unit implemented in the form of a computer-server, although other implementations are possible. The computing units are connected with each other via a data communication network. The network is a public network and assumed to be insecure and open to eavesdroppers. In the illustrated implementation, the network is embodied as the internet. In this context, the computers may or may not be connected to the internet at all times.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential”.

Hardware Structure and Components

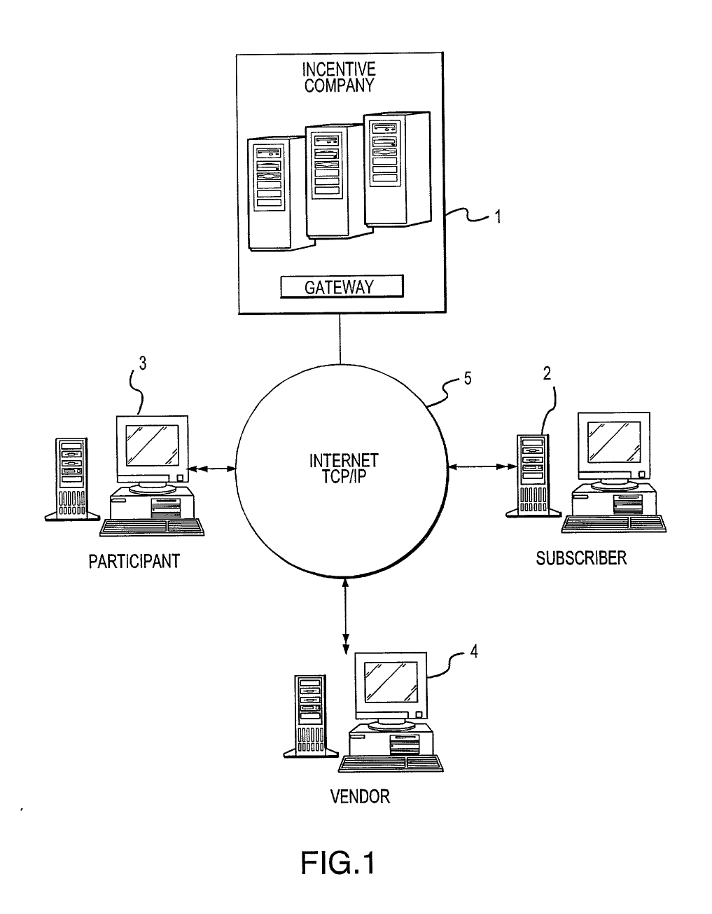

FIG. 1 depicts a schematic representation of the hardware components of an exemplary interactive incentive marketing system. The company providing the incentive marketing services (incentive company) 1, the subscribing company (subscriber) 2, the subscribing company's employees (participant) 3, and the vendor 4 are interconnected via a computerized network system 5 such as the internet. The internet and its various components are known in the art. The incentive company 1 can be any company or organization that utilizes or hosts the interactive incentive marketing application of the present invention. The subscriber 2 can be any company, business or organization that employs, contracts with or engages the incentive company to provide interactive incentive marketing services. The participant 3 is typically an employee of the subscriber, commonly a sales representative, area sales manager, production supervisor, or similar person engaged in the sales or manufacture of a commercial product or service. The vendor 4 may provide fulfillment product, i.e., the reward items that are available for redemption by the participant. The term “User” is commonly referred to throughout the specification and includes individual computer users who may be affiliated with any of the above entities, i.e., the incentive company 1, the subscriber 2, or the vendor 4.

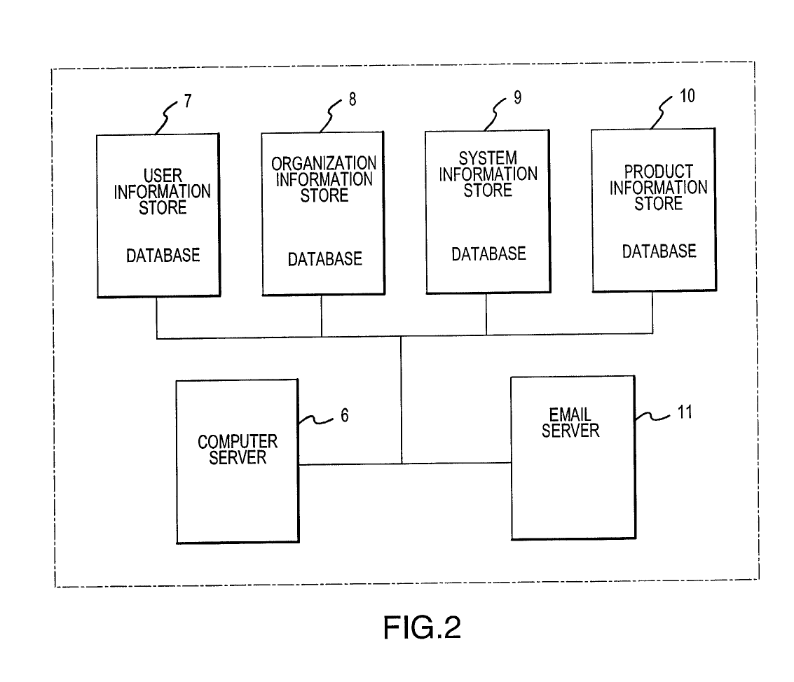

The computer server 6 is associated with the incentive company 1 for hosting the incentive marketing program application, as shown in FIG. 2. One skilled in the art will appreciate that server 6 may be hosted or operated by a third party. The incentive company's server 6 utilizes an operating system, such as the Microsoft Windows NT 4.0 and a web server such as the MS IIS4. The application server, such as the Alliance Cold Fusion 4.0, may also be used. The program code of the present invention makes it possible to host both the web server and application server on systems such as the Sun or HP hardware or utilize other operating systems such as Sun Solaris, HP Unix and Linux, Windows NT or Windows 2000. A number of different web servers are also supported. Therefore, the invention marketing program application can scale to main-frame proportion with minimal code re-writing. A 4-way Intel processor based computer with sufficient memory (e.g., 512 MB) or similar computer may host the database server. A separate SMTP-POP3 email server 11 may also be preferred. The entire incentive program is available utilizing any networking protocol, preferably TCP/IP. The incentive program application is a website based, HTML generated software program that provides textual and graphical interface, providing hyperlinks that are both internal and external to the program.

The program may contain a number of databases to store information relating to the incentive company 1, subscribers 2, participants 3, and vendors 4. As shown in FIG. 2, databases that are commonly referred to herein are the User Information Store 7, the Organization Information Store 8, the System Administration Store 9, and the Product Information Store 10. The program is capable of comparing and associating data from all databases. The system of the present invention is also capable of generating a subscriber-specific website that mimics the look and feel of the subscriber's own website so as to appear as if the incentive company's website is a continuation of the subscriber's. In essence, the incentive company's website morphs to the look and feel of the subscriber's website by sharing similar HTML code, framing techniques or other known in the art methods.

System Processes and Operation

User Log-in and Sign-up

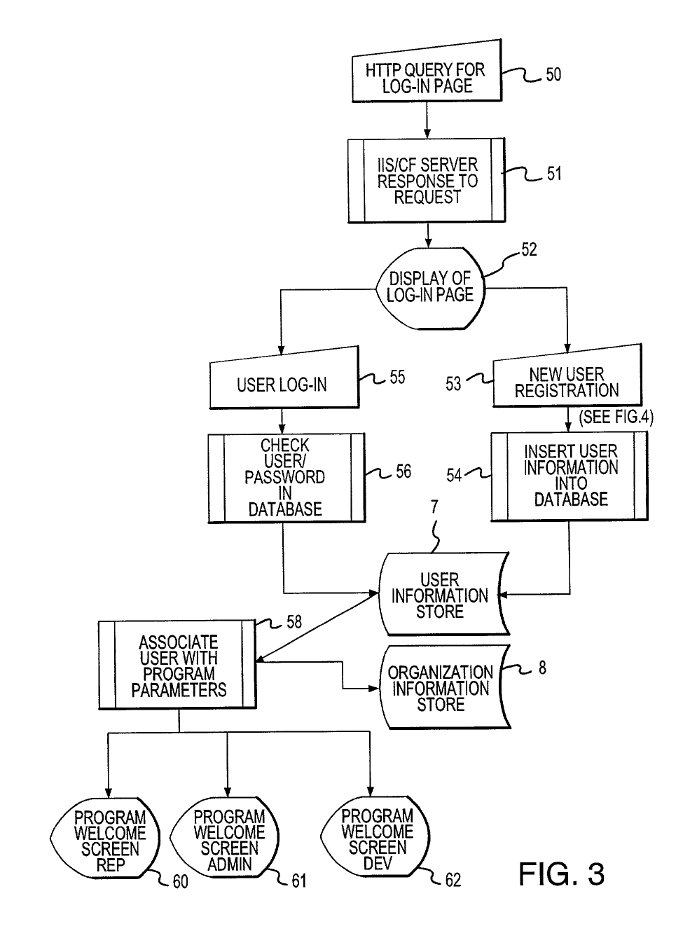

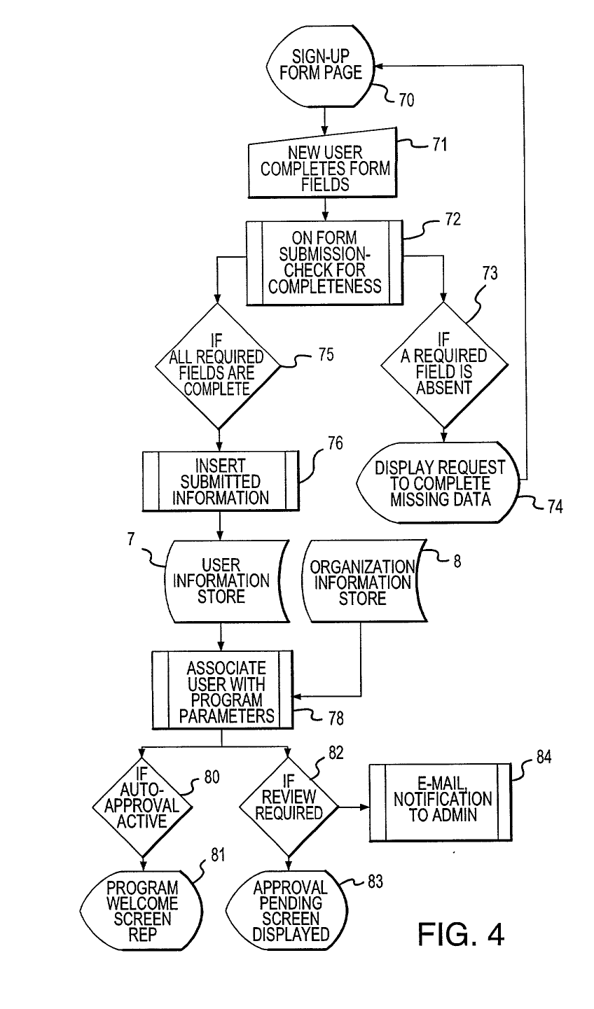

A user gains initial access to the incentive marketing program through a computer network such as the internet. In an exemplary embodiment shown in FIG. 3, a user enters an HTTP log-in address (step 50) into a web browser on the user's remote computer, wherein the HTTP address directs the user's browser to the incentive company's website—this website is generally set-up to mimic a specific subscribing company's website. The website server responds to the user request (step 51) by displaying to the user a log-in page 52. The user is provided with the option to log-in as an existing user 55 or register as a new user 53. FIG. 4 depicts a typical new-user registration process and is described in detail later.

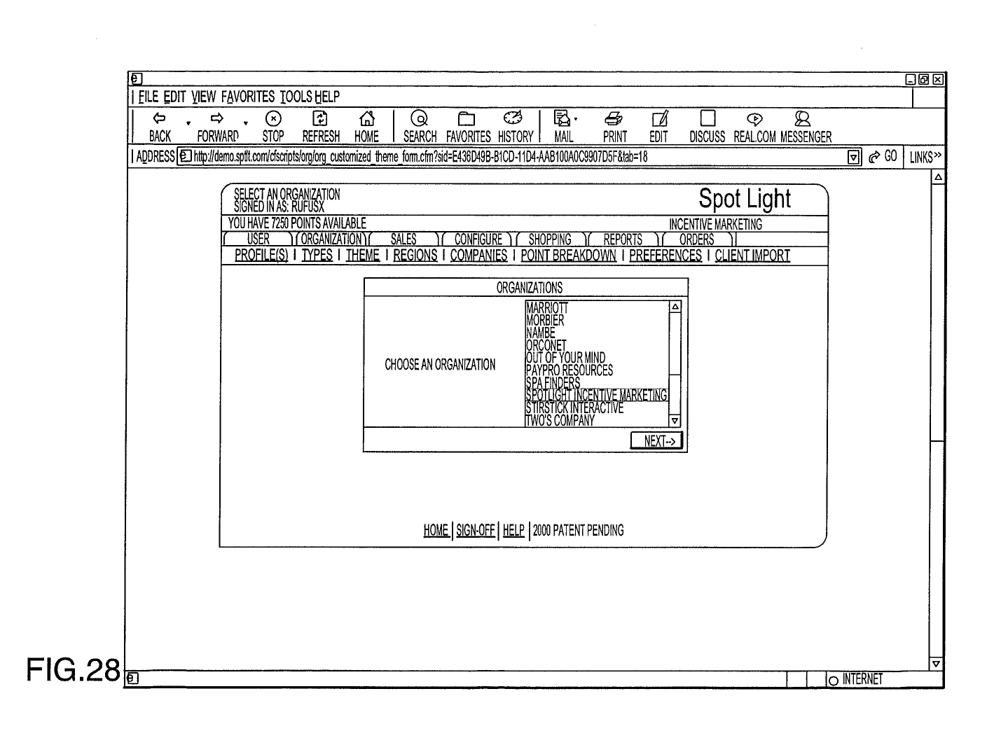

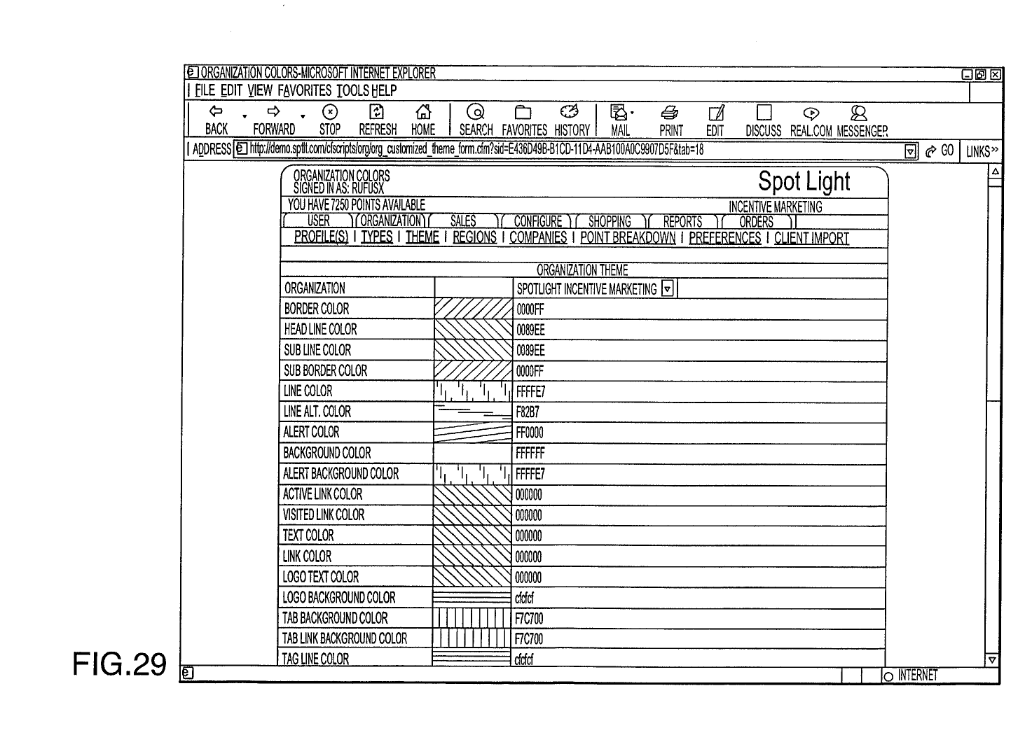

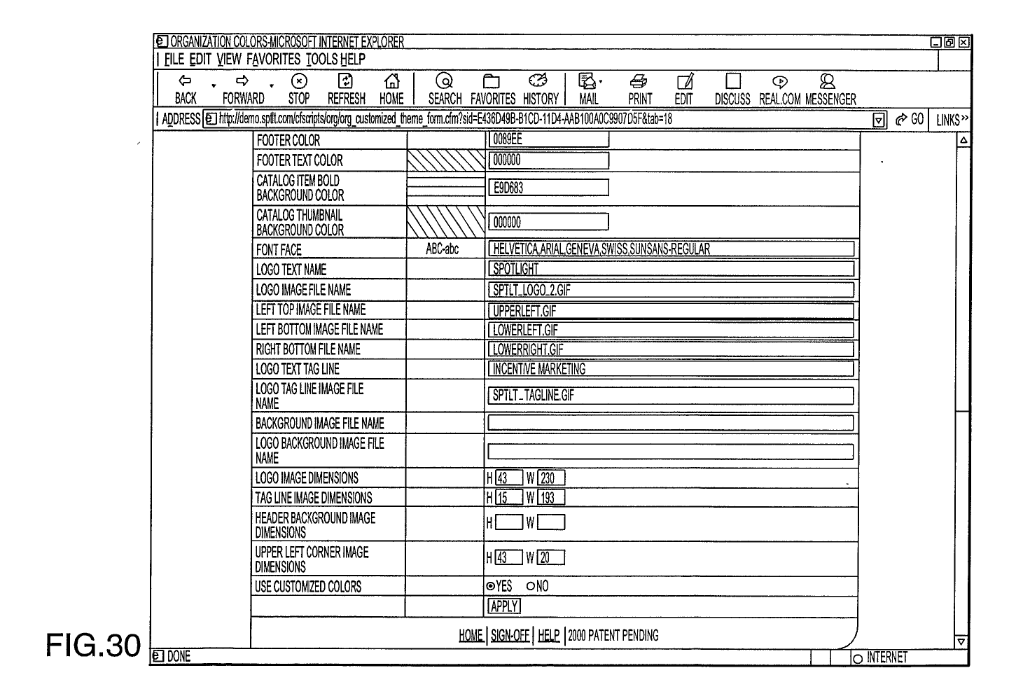

FIGS. 28-30 are web page screen shots of an exemplary feature of the present invention for requesting information from a given user to modify web screen parameters to mimic the look and feel (them) of the Subscriber's own website. FIG. 28 shows how a user selects the organization tab and then chooses from a list of organizations. The user is presented with a number of options at this point (See header tabs in FIG. 29). For example, the user is able to check profiles, types (roles), themes, regions, etc. FIGS. 29-30 specifically show how the program requests user information relating to the look and feel or theme desired. By entering the appropriate information, the user is able to generate an incentive program web site that mimics the look and feel of the subscriber's website, if desired.

Referencing FIG. 3, when an existing user logs in, the program confirms username and password from a user database (step 56) (e.g., a user information store 7) and associates the user with specific program parameters available from another database (e.g., organizational information database). For example, a user may be recognized, based on program parameters as a sales representative, system administrator or a program developer—each having different program associations and profiles. Accordingly, the program displays to the user a welcome screen confirmation of the user's status, e.g., user 60, administrator 61, developer 62, or other appropriate user-type.

As noted above, if an individual is not an existing user, he or she may register as a new user 53. An exemplary initial sign-up (or registration) website that a user completes before access is granted is shown at FIG. 4. From the subscriber's home page, a user selects the sign-up form page 70. The new user is requested to complete a number of fields 71 such as name, address, phone, SSN, etc. The field categories may be adapted for particular subscriber needs. Required fields are then checked by the program 72. If required information is missing from a field 73, the user is asked to reenter missing information 74. If all fields are complete 75, the information is submitted 76 and recorded in the user information database (e.g., user information store 7).

The user information is then associated with program parameters 58 that are found in the organizational information store database 8. Some users are automatically approved for access 80 based on standard comparison values and subscriber requirements. If a user is auto-approved 60 by the computer program, the user will be assigned a user profile and program permissions. Once auto-approved 80, the user is directed to a program specific welcome screen 81. If the user is not auto-approved, further review of the application is required 82. The user is notified that approval is pending 83 and the administrator is notified that there is a user application that needs reviewing.

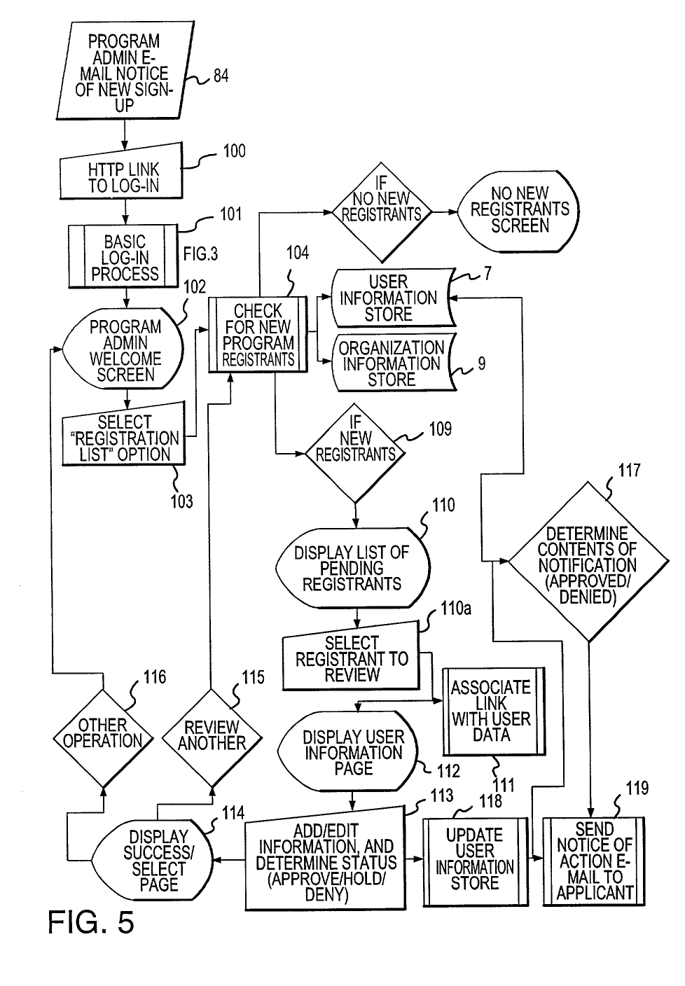

Referring to FIG. 5, which depicts an exemplary process for user sign-up approval, when a new user is not automatically signed-up under the specific program parameters, the program administrator is emailed a notice of a new sign-up 84. The program administrator logs into the incentive program 100 & 101. The program administrator selects the registration list 103 option at the welcome screen 102. The program administrator checks for new program registrants 104. The program checks the user 52 and program 107 information database for new registrants. If new registrants are found 109, a list of pending registrants is displayed 109. The program associates selection with user data 111 found in the user information store database 7 and displays user information on the web page 112. The program administrator is allowed to add or edit information in the user data file and may approve, deny or hold the application for later review 113. The user data is then updated 118 in the user information store 7. The program determines whether the application was approved or denied 117 and, that status, along with other action taken, is emailed to the new-user applicant 119. The program administrator is then shown a display success screen 114, at which point the program administrator may select to review another applicant 115. If the review is completed, the program administrator is queried regarding desires to perform another operation 116.

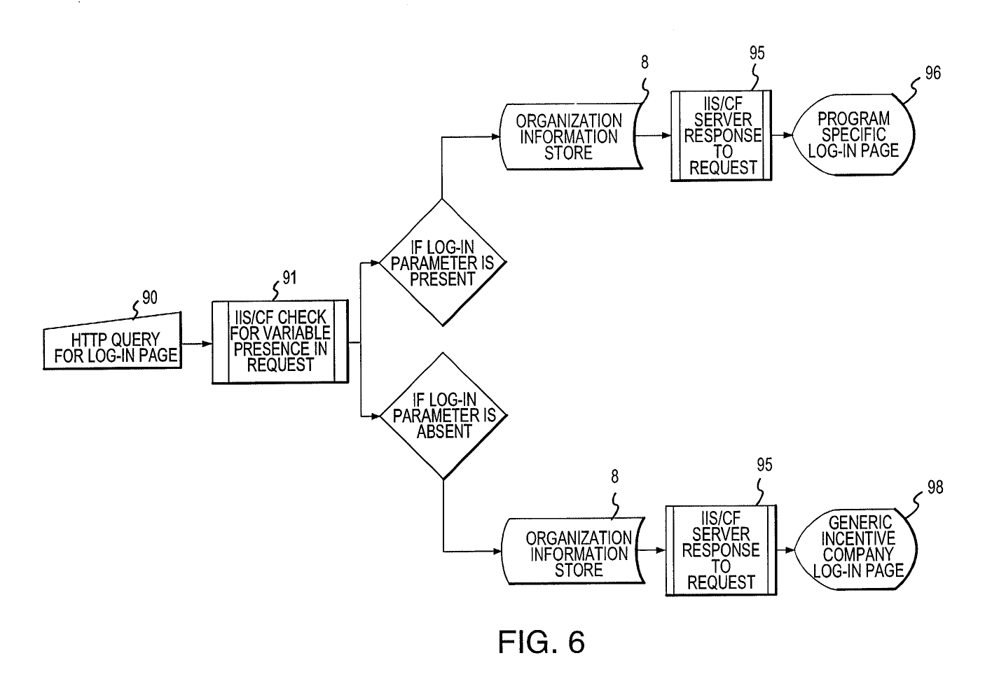

FIG. 6 provides an overview of an exemplary incentive program initialization and entry into the program specific incentive marketing application. As noted above, a user logs into the log-in page 90, a log-in request 95 is made to the server where the program compares the log-in information 91 with parameters found in the organizational database 8, and verifies that the log-in parameters are present. If log-in parameters are present, the individual is routed via association with the organizational database 8 to a program specific web page 96. If the log-in parameters are absent, the individual is routed to a generic incentive company web page 98.

An exemplary subscriber web page for a user—after initial sign-up—is shown in FIG. 40.

User Profiles, Roles, and Permissions.

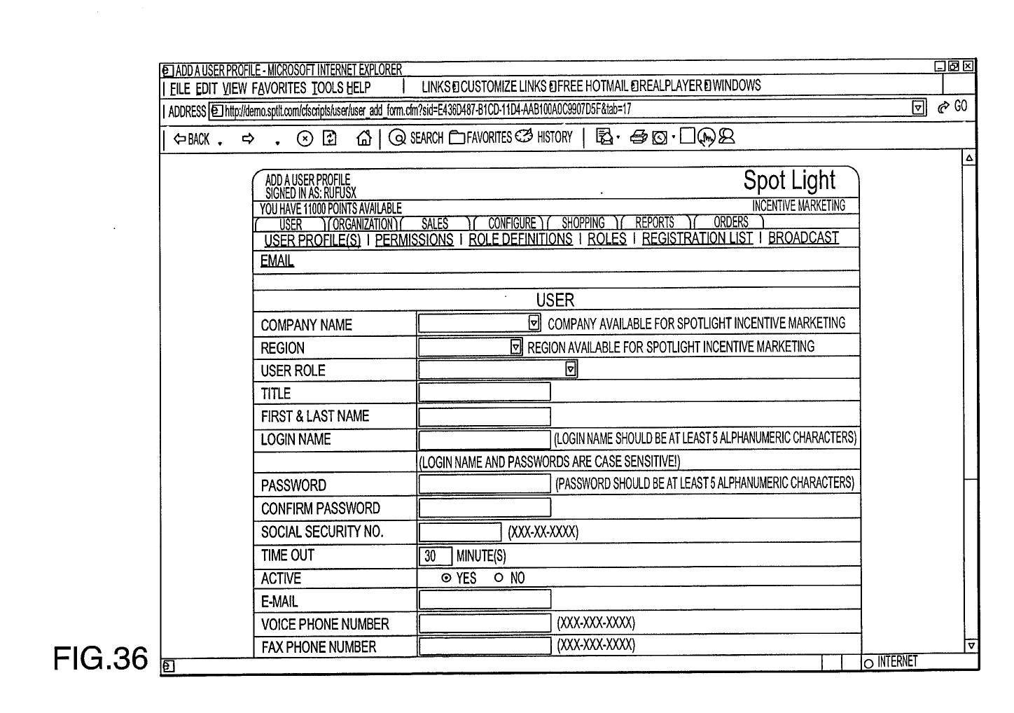

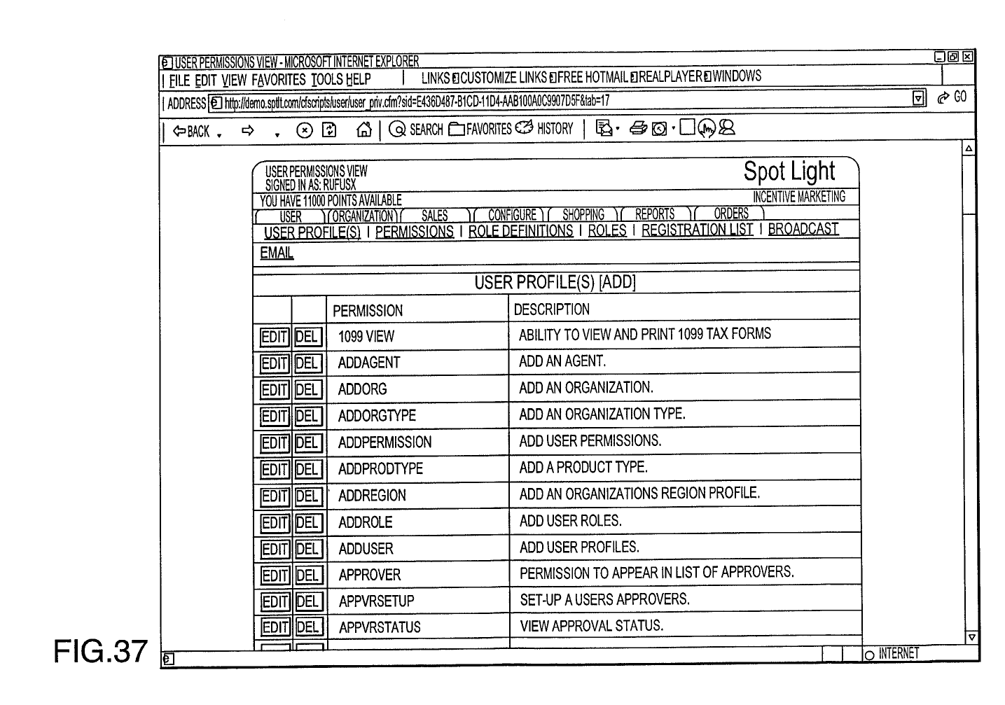

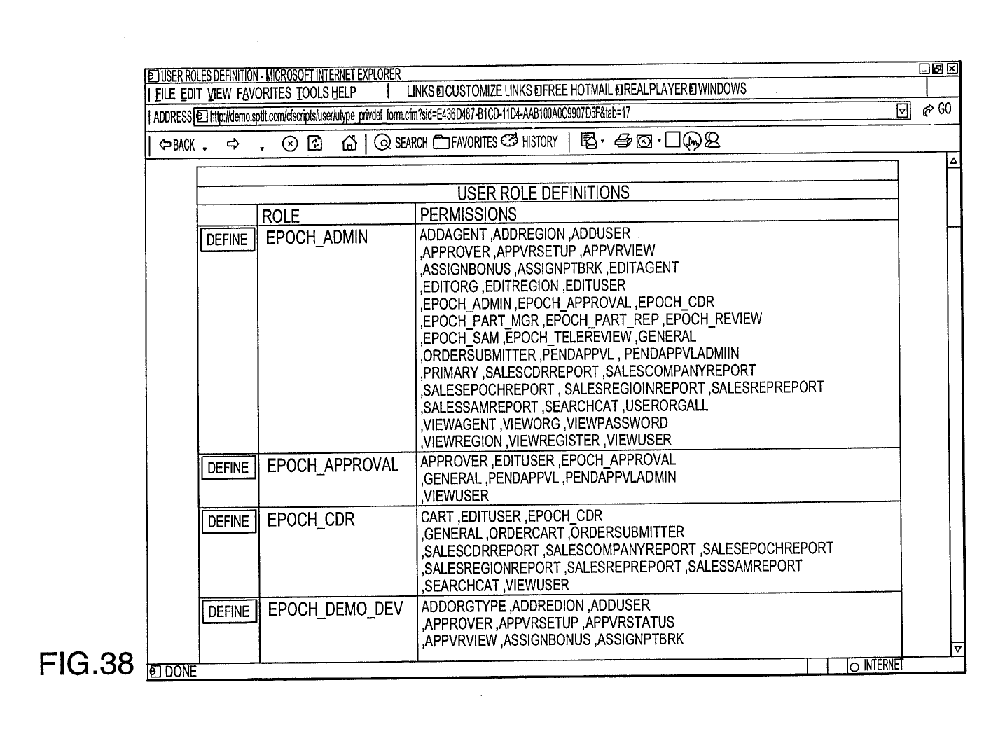

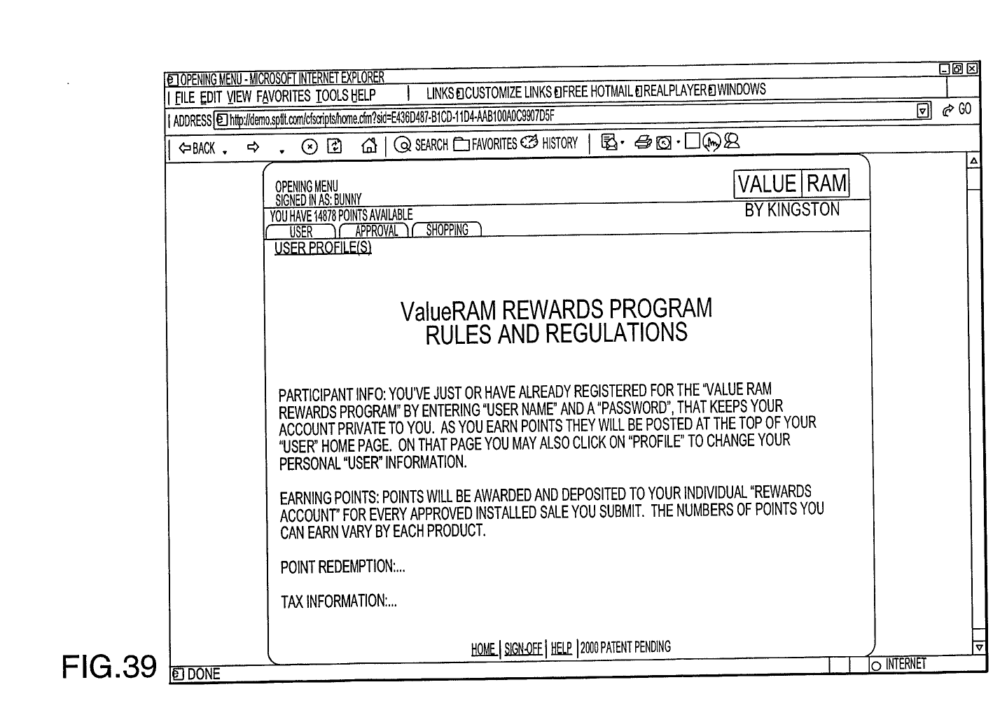

The present invention is configured to allow authorized users to input, track, report and adapt to large amounts of data, including, among other things, data relating to sales, production costs, prizes, product information and employee instruction. To effectively facilitate these and other tasks, the program incorporates very well-defined user profiles. A user PROFILE defines the user and the user's access to various program information. For example, the PROFILE information in the user information store database 7 provides detailed data about the user, e.g., name, address, phone number, subscribing company or vendor affiliation, program ROLE (administrator, sales rep, manager, etc), and program PERMISSIONS (access to program information). A ROLE defines how an individual participates in the incentive program operation. For example, a specific incentive program application may include ROLES for sales managers, sales representatives, production staff, system programmers and program developers, to name only a few. Each ROLE may be assigned a variety of program PERMISSIONS, to permit a specific user (or group of users) to have specific access to program information. Exemplary web pages of the profile, role and permissions features of the present invention are provided in FIGS. 36-39.

An exemplary embodiment of the present invention involving a sales representative ROLE may provide PERMISSIONS to input sales information, retrieve product information, review a merchandise catalog and redeem incentive points. That particular ROLE, however, will not necessarily have PERMISSIONS to allow the sales representative to change certain program parameters relating to product point values, create a special bonus program to award special bonus points, to approve sales or to award points. However, a ROLE defined for a Sales Manager may provide all PERMISSIONS above. One embodiment of the present invention (described below) shows a system for inputting PROFILE information, defining ROLES and assigning PERMISSIONS. It should be appreciated that ROLES and PERMISSIONS can be created and modified by any authorized user (generally reserved for in-house program developers or administrators). These ROLES are not set or static roles or actions. It should also be noted that in addition to the security provided by the ROLES AND PERMISSIONS features of the present invention, session or user security is assured by using “Session IDs” to identify any individual user's data and session activity. Session IDs, for example, can be randomly generated 128 bit encrypted alpha-numeric strings that are the means by which all information sent to and from the user's browser is tracked and associated within the application. These Session IDs have time-out settings that can be varied by organization and role. Therefore, when a session “times-out,” the user is automatically disconnected and the content databases are disassociated from that particular Session ID. So even if an individual “bookmarks” a page within the application, in an exemplary embodiment, the page cannot be reentered after having been disconnected. Log-in is required, and a new Session ID is generated and assigned to the user's data.

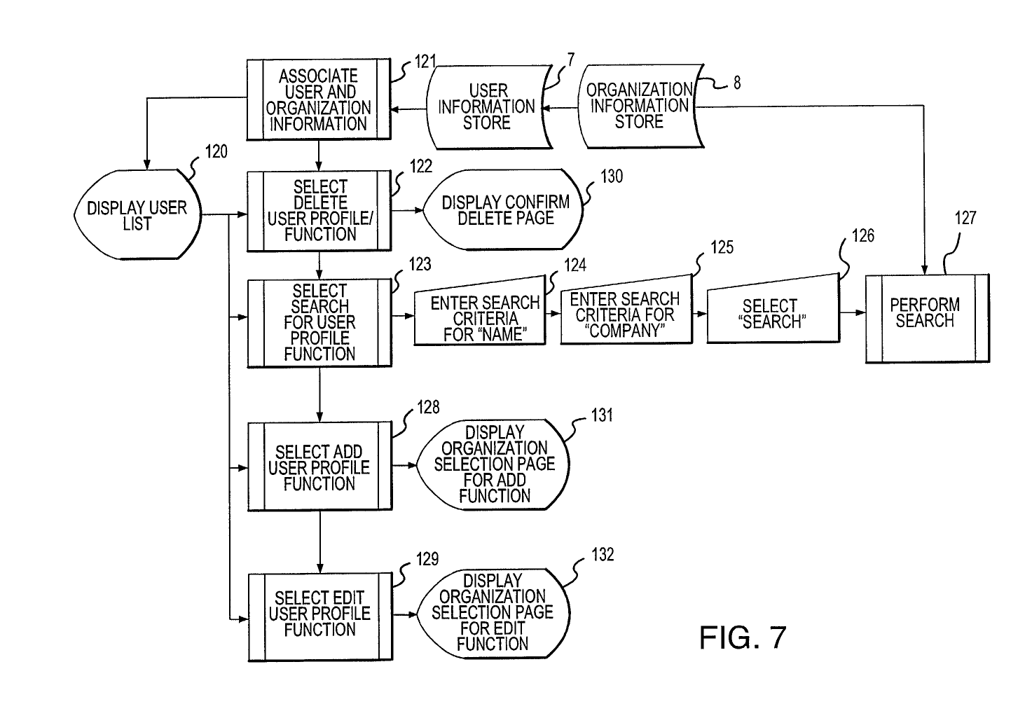

FIGS. 7-12 depict an exemplary system for adding, deleting, modifying, and defining user profiles. In FIG. 7, from a Display User List web page 120, the following typical user functions may be performed: (1) Associate User 7 information with Organization 8 information 121, (2) delete User profile 122, (3) Search for User profile 123, 126-27, by name 124 or by company 125, (4) add a user profile, or (5) edit a user profile 129, 132.

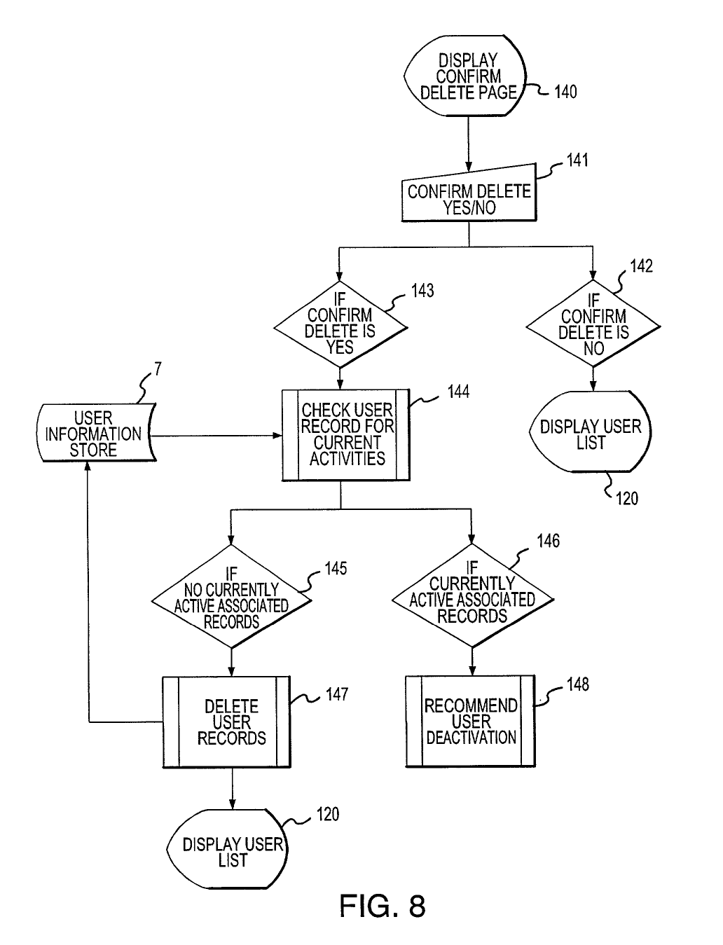

FIG. 8 depicts an exemplary delete user system, where once a user delete operation is selected from a web page providing a User List, the user is asked to confirm deletion of the user 140 and the user confirms yes or no 141. If deletion is not confirmed 142, the user list is then redisplayed 120. If the user deletion is confirmed 143, the program checks the user record for current activities 144 by comparing with information in the User Information Store 7. If there are no currently active records associated with user 145, the user records are deleted 147 from the User Information Store 7, and the Display User List is redisplayed 120. If there are currently active associated records 146, the program recommends User deactivation instead of deletion 148.

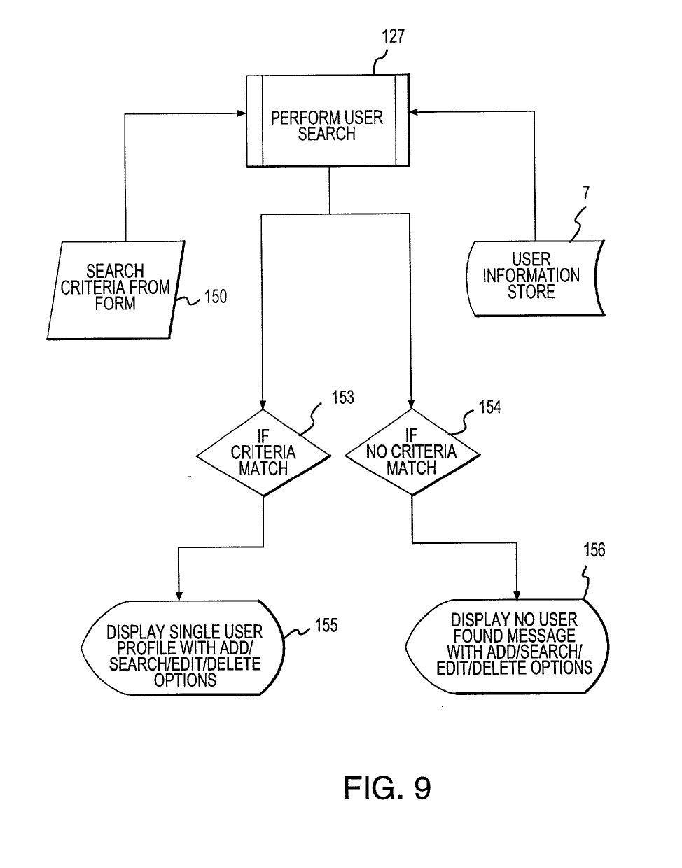

An exemplary User Profile Search system is shown in FIG. 9. A search form 150 is provided on a web page that enables searching according to one or more database fields. The program initiates a user field search 127 by comparing data from search form 150 with information in the User Information Store 7. If search criteria is matched 153, the User and profile are displayed with various operands (e.g. add, delete, search edit). If no records match the search criteria 154, the display indicates that no user was found 156.

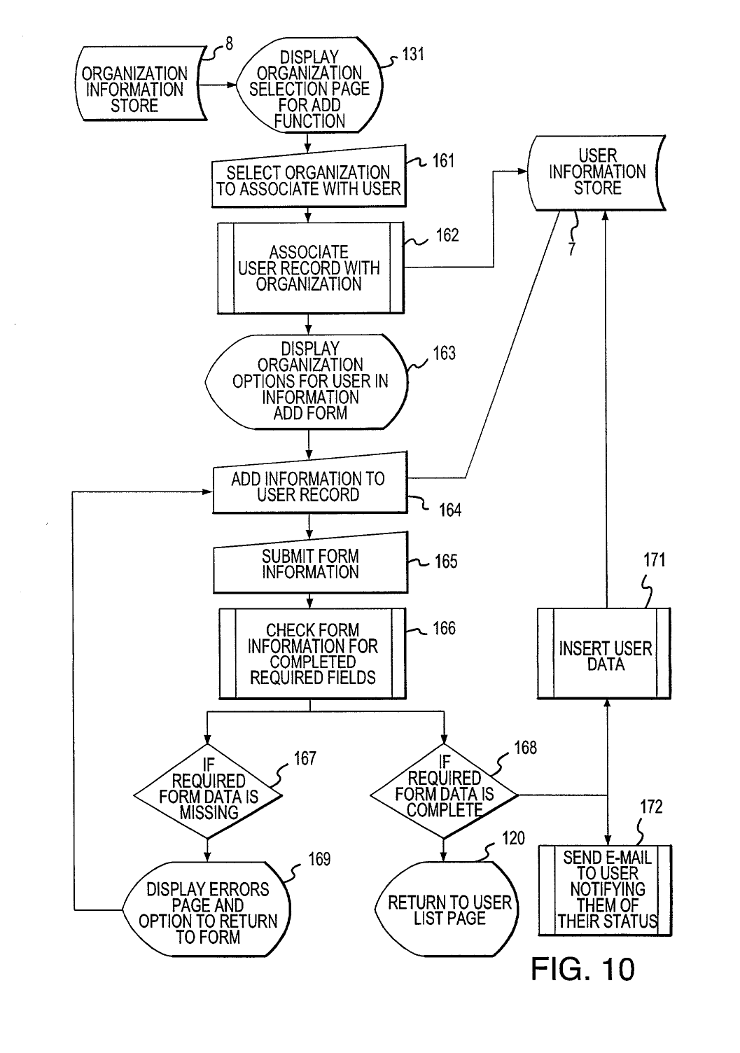

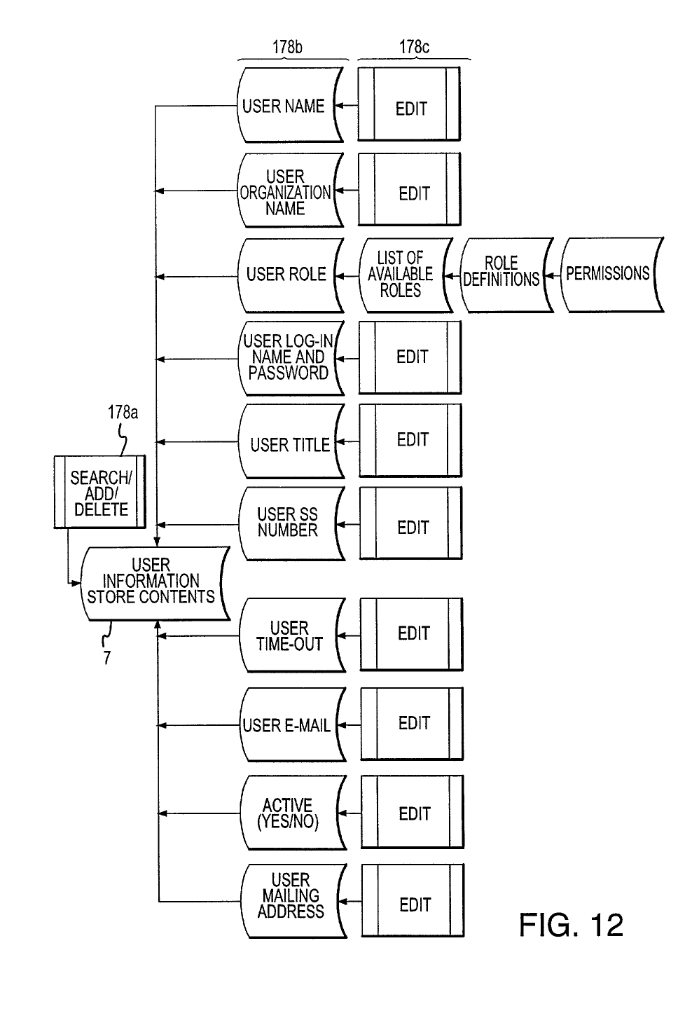

FIG. 10 provides an exemplary system for adding user profiles. In the Organization Selection Page an individual selects the Add function 131 and selects an organization to associate with the new user 161. The new user is then associated with one or more organizations 162 and the user options for that particular organization is then displayed 163. Information is then added to the user record (see FIG. 12), e.g., name, role log-in, password, title, email. The information is submitted 165 and checked by the program for completion of the required fields 166. If data fields are substantially complete 168, the program returns to the User List Page 120, automatically sends email notification to user 172 and automatically updates user data 171 in the User Information Store 7. If the data fields are substantially incomplete 167, the program displays the Errors Page and provides the option to return to form 169.

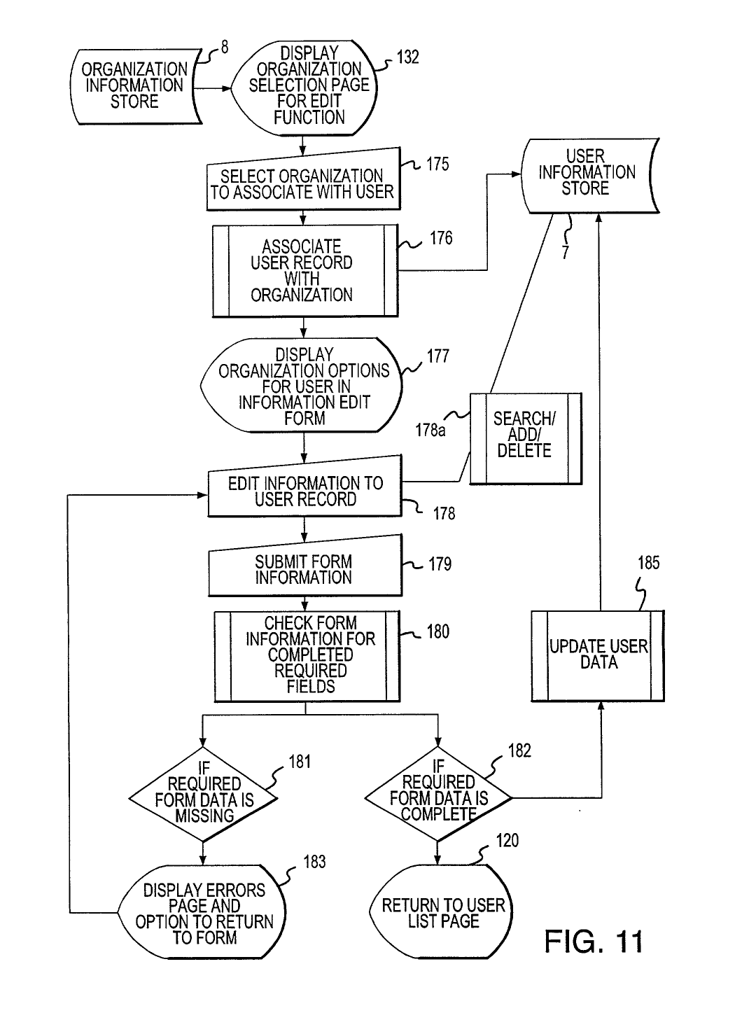

An exemplary system for editing User Profiles is depicted in FIG. 11. The User selects the Edit Function from the Organization Selection page 132. An Organization is associated 175 with the user 17. The User Information Edit function is selected 177 and the user information (see FIG. 12) is edited 178. The edited information is submitted 179 and checked by the program for completion of the required fields 180. If data fields are complete 182, the program returns to the User List Page 120, and automatically updates user data 185 in the User Information Store 7. If the data fields are incomplete 181, the program displays the Errors Page and provides the option to return to the form 183.

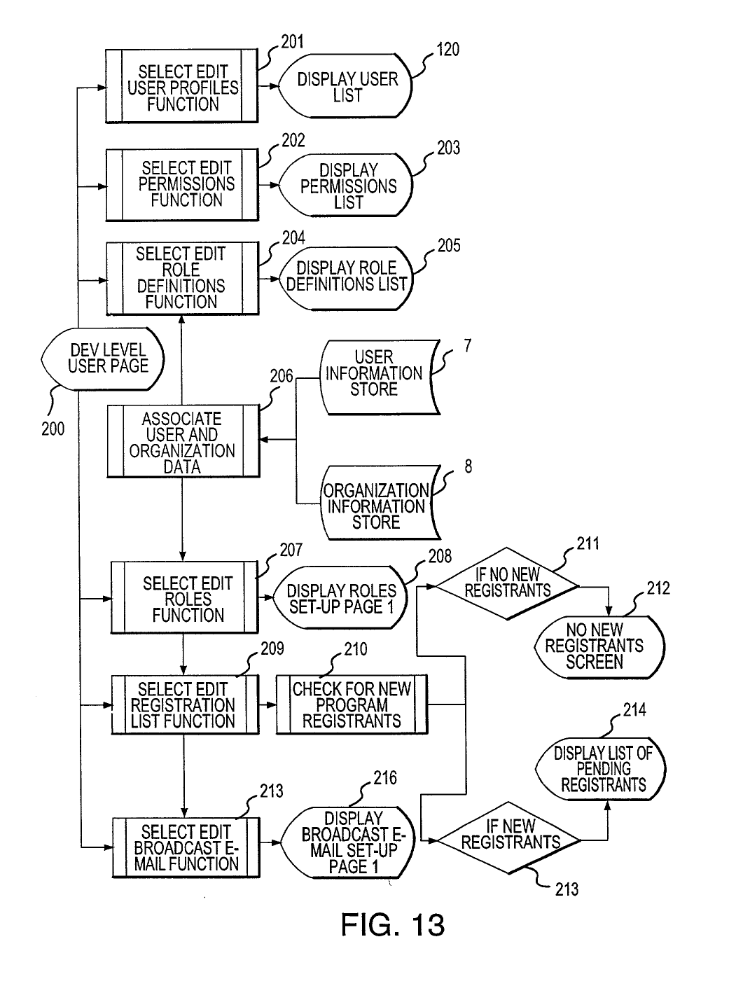

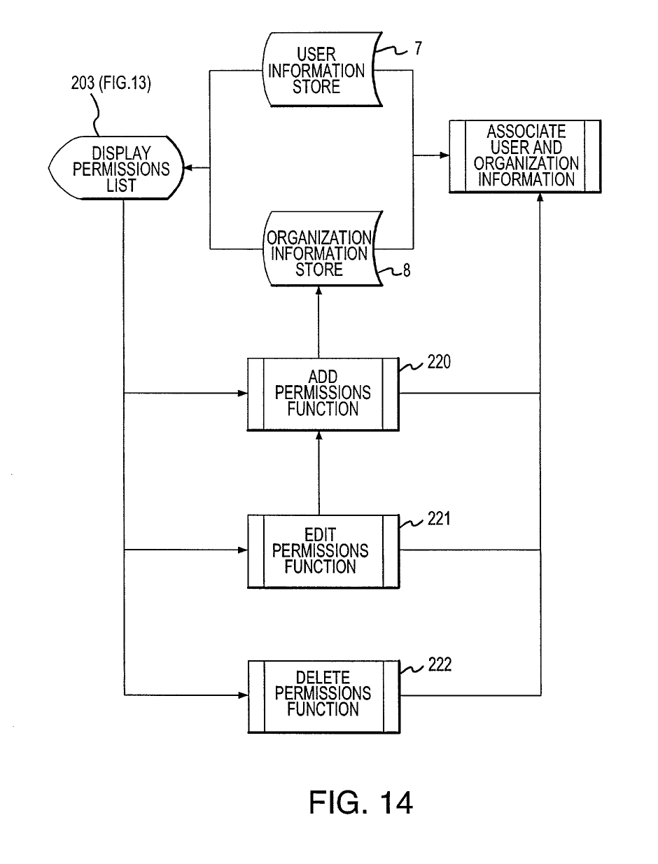

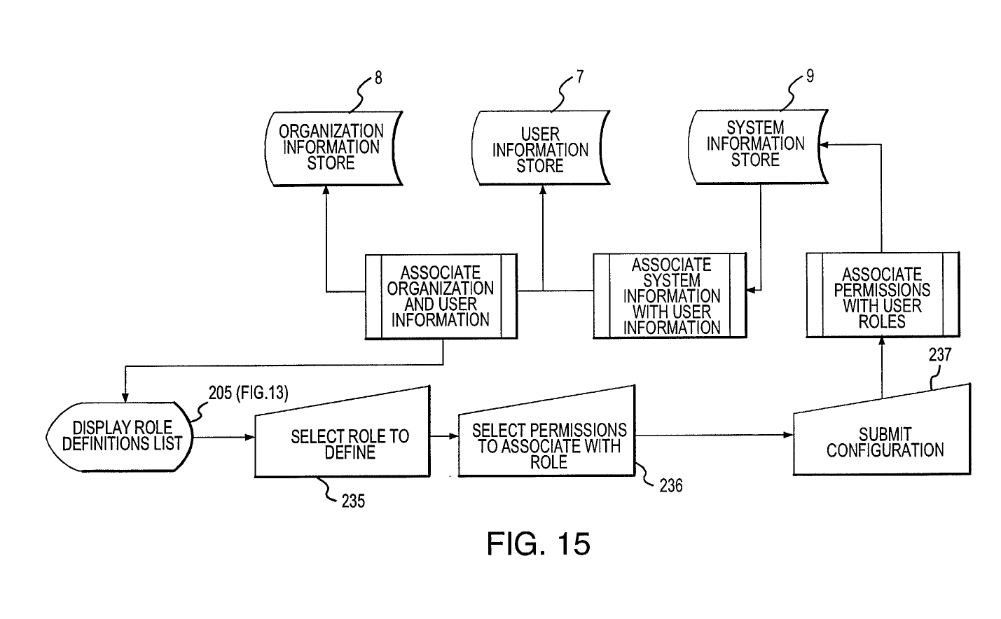

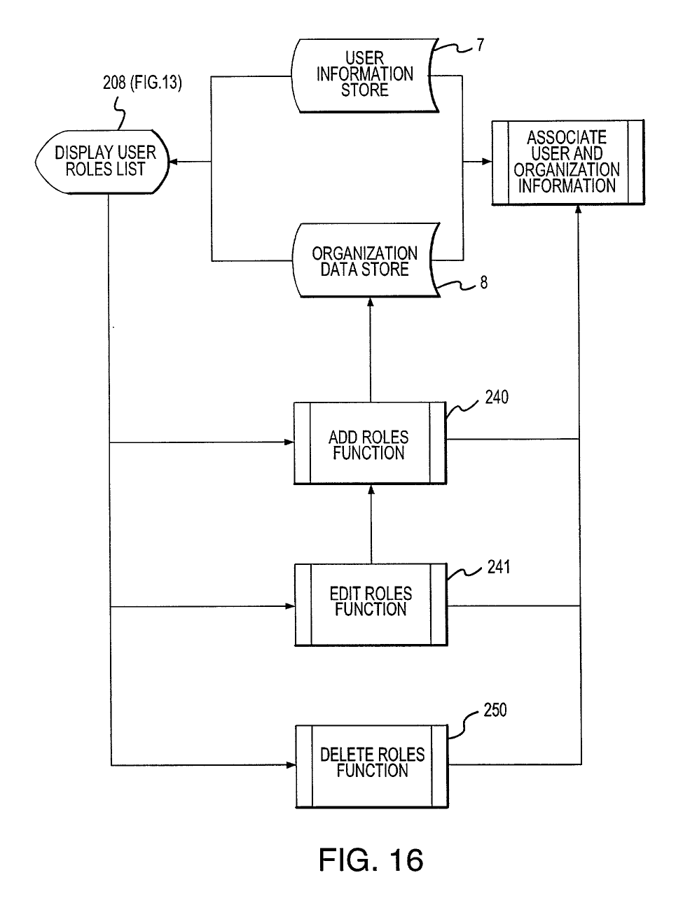

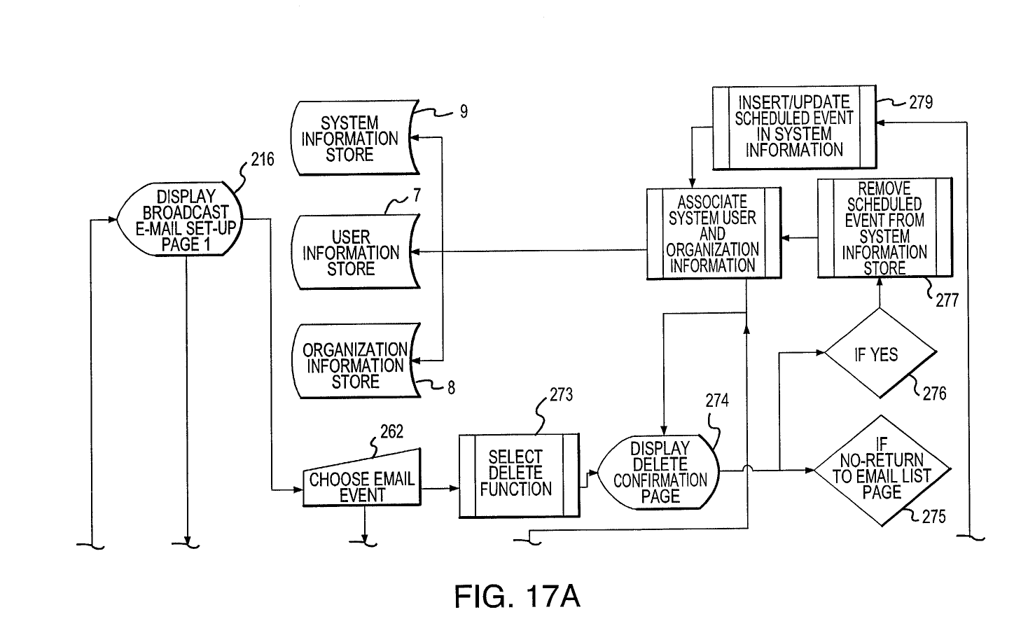

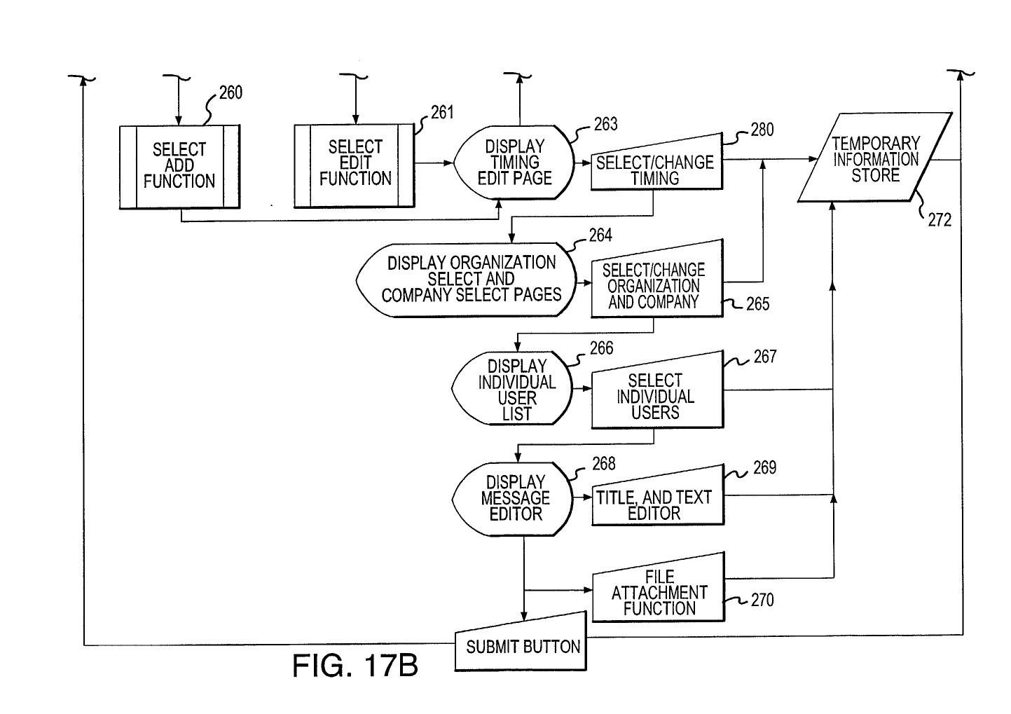

The Incentive Marketing System of the present invention comprises a flexible and powerful application that allows the programmer to set various roles and permissions according to the requirements and needs of particular subscribers, vendors, employees and the incentive marketing company. Accordingly, FIG. 13 depicts an overview of the various systems which may be utilized by the program to define and edit profiles, roles and permissions. As described above and shown in FIGS. 7-12, the edit profiles functions 201 are highly configurable. Additionally, the program developer or administrator may add and modify program PERMISSIONS by selecting the Select Edit Permissions Function 202 from the Developer Level User Page 200, at which time the Permissions List is displayed 203 (See FIG. 14). Likewise, if the Developer desires to edit the Role Definitions, the Developer selects the Role Definitions page 204 (See FIG. 15). The other functions provided by this program allow the developer to edit ROLES 207 (see FIG. 16), edit the REGISTRATION LIST 209, and edit Broadcast e-mail 215 (see FIG. 17).

To edit the REGISTRATION LIST function, the developer initiates a check for new program registrants 210. If no new registrants are found 211, the No New Registrants screen is displayed 212. If new registrants are present 213, the program displays a list of pending registrants 214.

FIG. 14 shows a typical system for modifying the permissions list. From the permissions list display 203, the developer can add 220, edit 221, or delete 222 permissions.

An exemplary system and method for defining user roles is shown in FIG. 15. First, the developer selects a Role to Define 235 from the Role Definitions List 205, e.g., program administrator, sales representative, manager. The Role Definition List provides the programmer with the option to select a preexisting definition for a given role, or to define a new definition tailored to a specific subscriber or vendor. For example, a subscriber may desire to define a particular role for a marketing consultant with a unique permissions set. In this case, a special role could be defined with unique permissions. Second, the developer associates various permissions with the marketing consultant ROLE 236. Finally, the new configuration for the ROLE is submitted 237 and is thereafter associated with the user in the System Information Store 9, User Information Store 7 and Organization Information Store 8. FIG. 16 is a further schematic depicting a preferred embodiment for adding 240, editing 241, and deleting 242 roles.

One of the key features of the present invention that overcomes problems with the traditional incentive marketing programs, is the ability to tailor a broadcast email system that is responsive to ongoing market developments. Although any number of SMTP/POP3 E-mail server hardware/software platforms may be used with the present invention, the lpswitch I-Mail has been know to work well. The broadcast email system of the present invention overcomes problems found in the traditional incentive marketing programs because it is capable of automatically and immediately notifying users of various events (e.g., registration/sign-up, special bonus programs, profile changes, etc.). Email notification is automatically responsive to market developments. For example, the automatic email broadcast may send motivational or informational emails in response to a given event (e.g. product sale), a non-event (e.g. no sales), or on a timed bases (e.g., once a month). An exemplary system and method of the Broadcast Email feature is depicted in FIG. 17. As shown in FIG. 17, the Developer has the option of choosing from an existing email event 262 (e.g., registration notification) or tailoring a specific email event 260 (e.g., notice of special incentive contest). If an existing email event is chosen, the user may desire to edit the email via the edit function 261, or, if the developer desires, the email event can be deleted 273-277. When a new email event is created, the user selects the Add function 260 from the Display Broadcast E-mail Set-up page 216, and is presented with the Display Timing Edit Page 263. The user selects the time and frequency of email disbursement 280 from the Display Timing Edit Page 263. The Display Organization Select and Company Select pages 264 are then presented to allow the user to select or change 265 the company/organization information. Individual email recipients are then selected 267 from the User List 265. The message (e.g., award contest ends tomorrow) is entered by a message editor 268, 269. The file attachment function 270 is selected if files are to be attached to the email. Throughout the email generation, various event information is stored in a temporary location 272, pending release and insertion of the scheduled email event into system administration 279. The email broadcast is then sent out according to the predefined parameters.

Sales Reporting and Approval

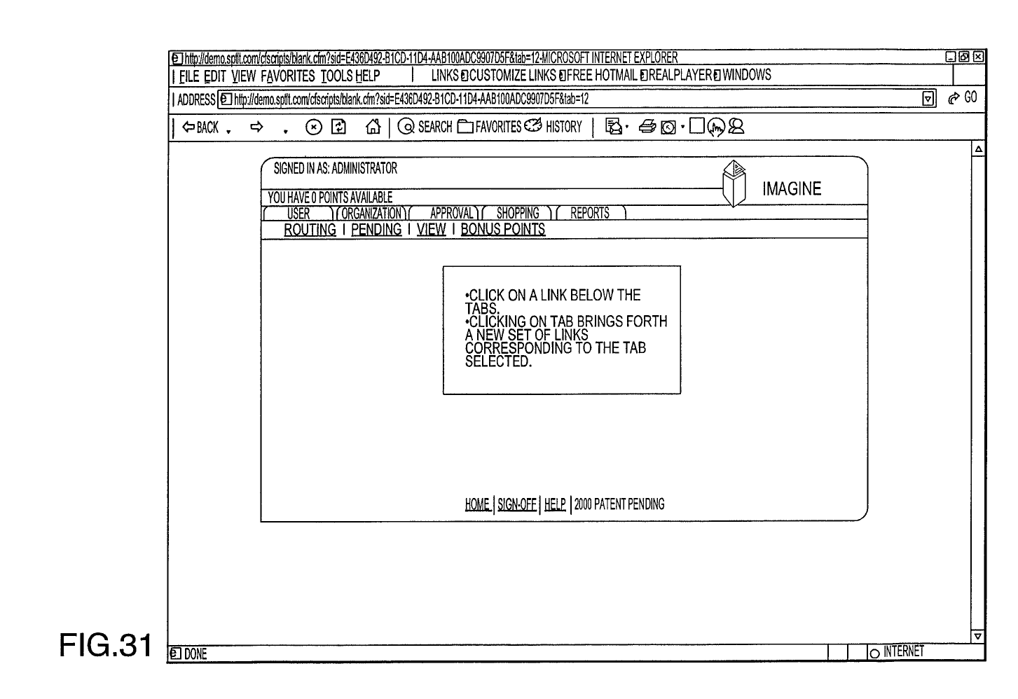

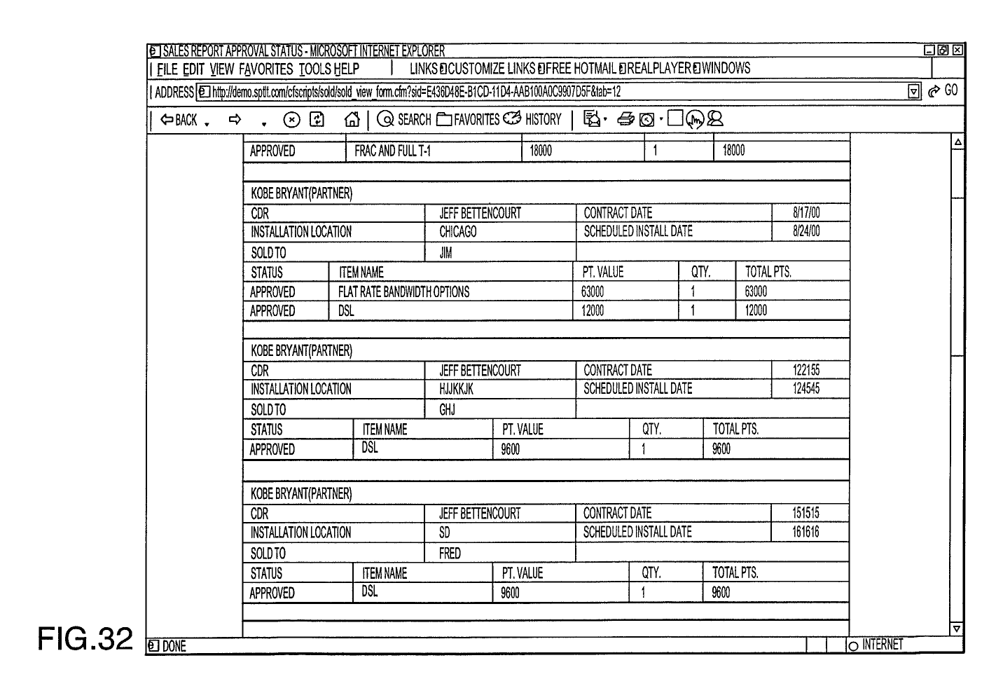

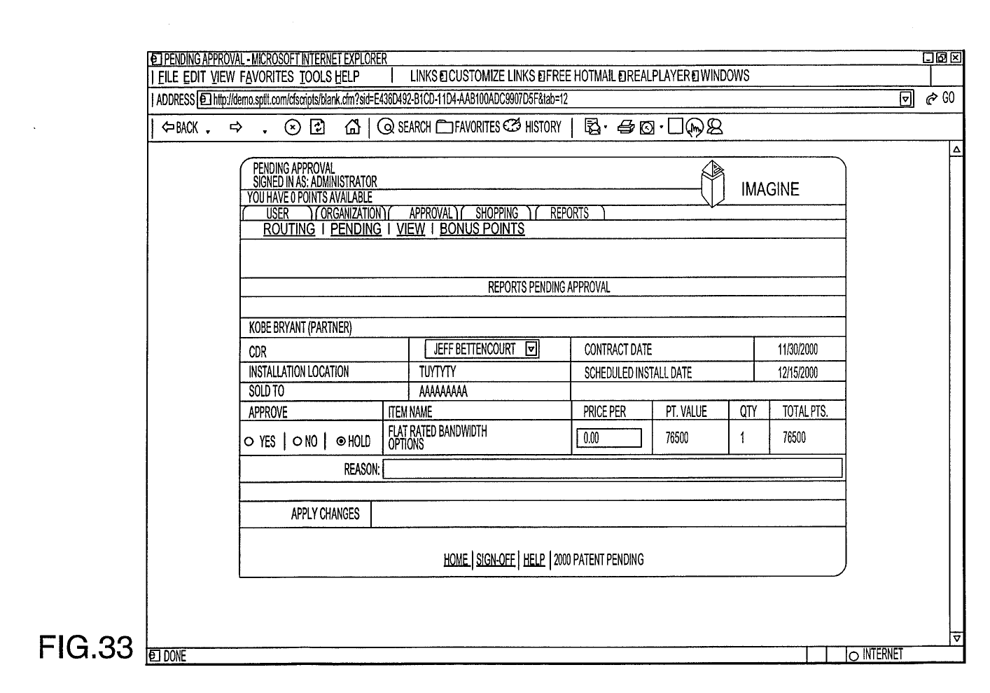

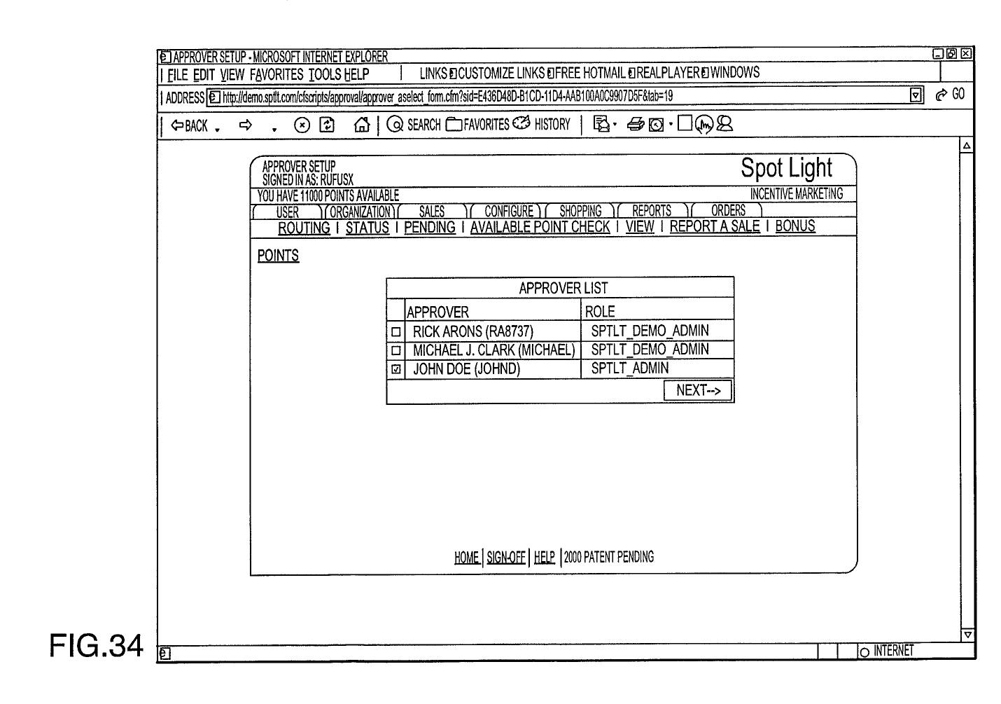

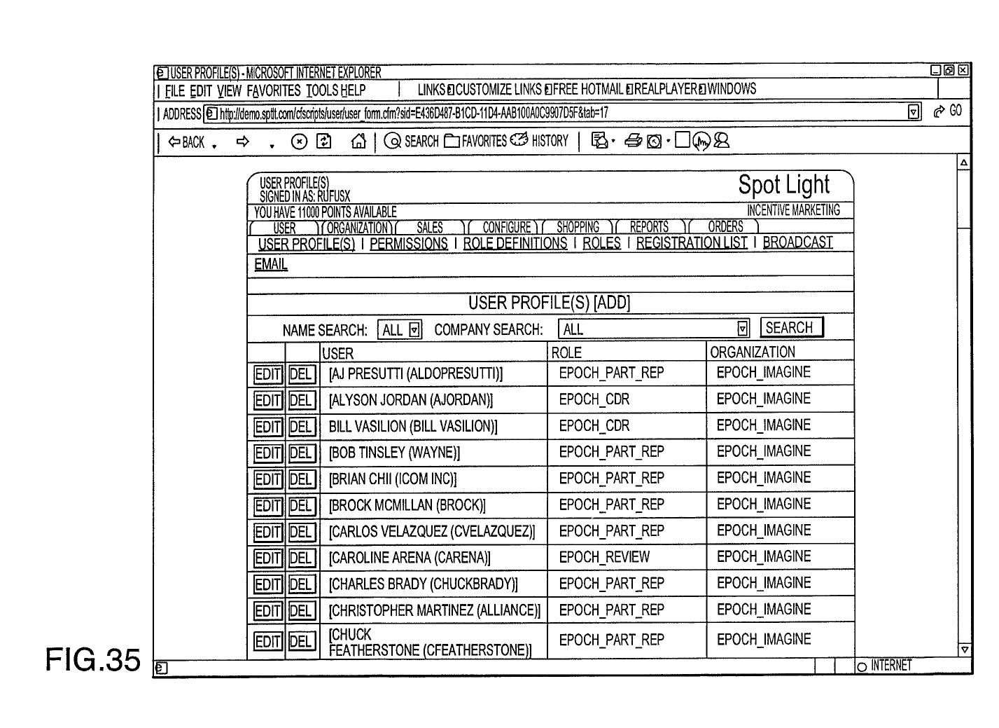

An exemplary system of the present invention enables a User (e.g., sales representatives), once he or she has made a sale, to input the sale information directly into this program via online access to the incentive program website. After this entry, the User's sales report shows that the sale is pending approval. While some sales may be automatically approved according to the specific subscriber's pre-determined approval parameters, other sales will need to be approved by a user that has authority to approve sales (e.g., a sales manager). Once these sales are approved, incentive points are assigned to the User. The user may then go online to access a virtual merchandise catalog to redeem those points for merchandise or other reward prizes. FIGS. 31-35 show exemplary screen shots of sales reporting and approval web page tabs and processes.

Another aspect of the present invention is the ability of the interactive marketing system to report and track product sales; and to record and track value points that are associated with product sales. When sales representatives sell products, they are awarded incentive points for those sales. Depending on the importance of a particular product sale, points can be adjusted to effect sales behavior, i.e., encourage or discourage sales representatives from concentrating their sales efforts in a given product line.

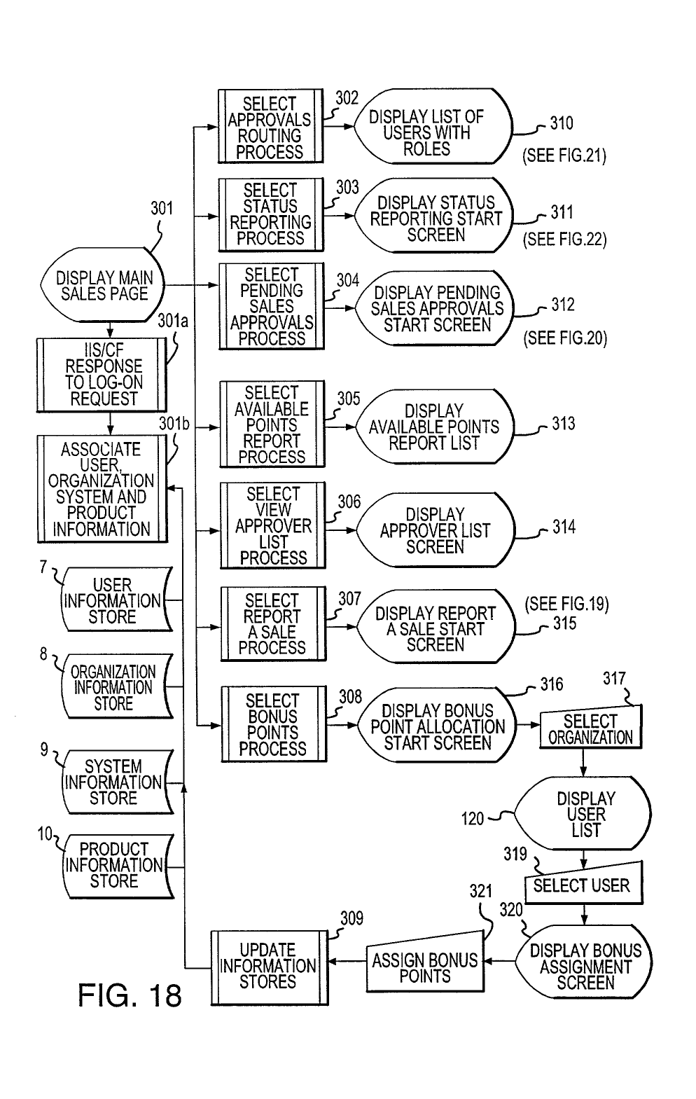

An exemplary embodiment of the system and method of sales reporting feature of the present invention is depicted in FIGS. 18-22. FIG. 18 is a schematic of the Main Sales Page 301 of the present incentive marketing system. After an individual logs-in (step 301a), the user is presented with options to (1) select approval routing process (step 302), (2) select Status Reporting process (step 303), (3) select Pending Sales Approvals process (step 304), (4) select Available Points Report process (step 305), (5) select View Approver List process (step 306), (6) select Report a Sale process (step 307), and (7) select Bonus Points process (step 308). Although the reporting and approving processes described herein relate to product sales and rewards for those sales, one skilled in the incentive marketing industry would appreciate that the systems and methods described herein may be easily adapted to a number of other business activities where the reporting, tracking, and communication and interconnectivity features of this invention would be beneficial, e.g., manufacturing goals, quality control parameters, etc.

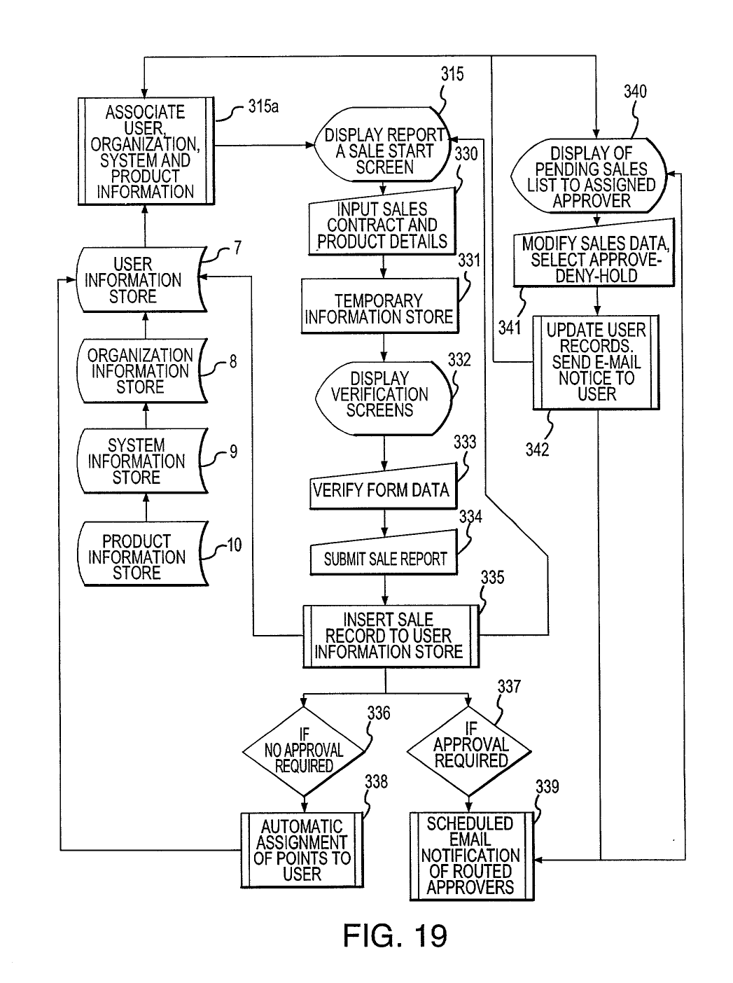

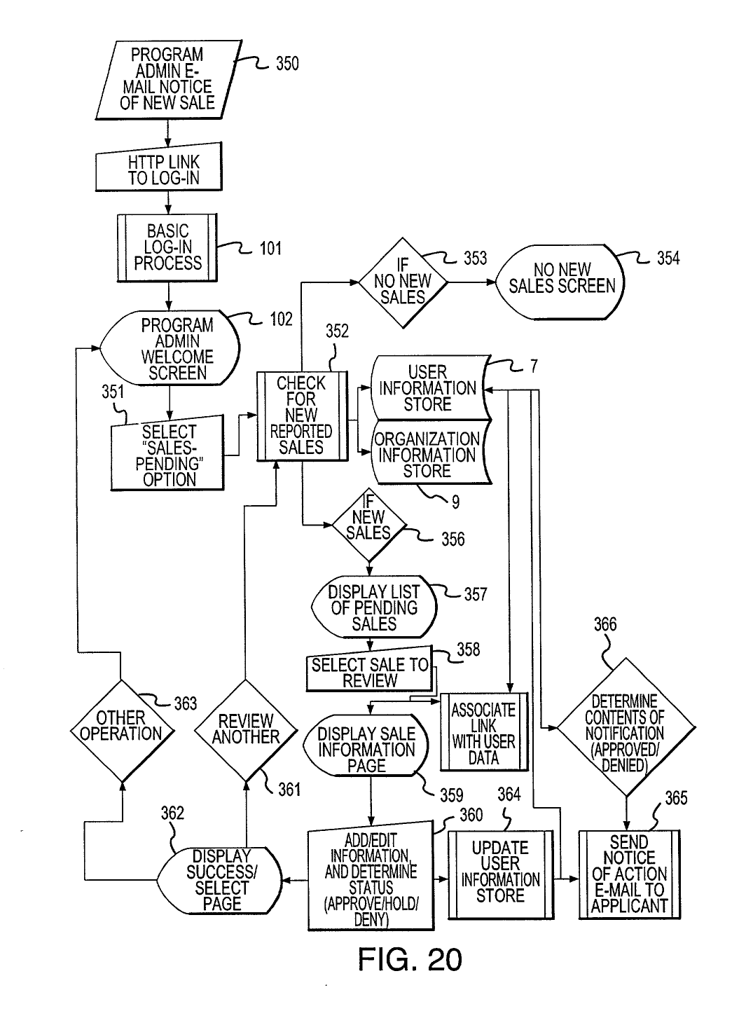

The sales reporting and approving process is similar to the registration approving process previously described, where some sales may be auto-approved in accordance with subscriber-specific program parameters and some sales need to be routed through an approval process to ensure the sale is appropriate and the proper amount of incentive points are awarded. FIG. 18, generally described above, depicts the exemplary steps for reporting sales, approving sales and awarding points. This overall sales process starts with the initial sale by an individual, e.g., a sales representative. FIG. 19 depicts an exemplary system for reporting sales. The User (e.g., sales representative) logs-in to the incentive marketing website, pulls up the Report a Sale Start screen (step 315) and inputs sales information according to subscriber-specific form parameters (e.g., sales contract and product details). This information is temporarily stored (step 331) and then repeated back to the user for verification (step 332). The User verifies the form data (step 333) and submits the sale report (step 334) for approval. The sale record is then inserted (step 335) into the User Information Store 7 as a “pending approval” sale. The program then compares the sale data with the subscriber-specific program parameters to determine if approval is required. If no approval is required 336, the sale is automatically approved and incentive points are automatically assigned to the User (step 338). If approval is required 337 (see FIG. 20), an email notification is routed to one or more designated approvers (step 339) and the approver may either modify, approve, deny or hold the record sale (steps 340-41). After approval, the User Information Store 7 is updated to reflect the added incentive points for the sale.

FIG. 20 further describes an exemplary Pending Sales Approval process. After an administrator, i.e., a User having a Role with administrative permissions, receives an email indicating that there are pending sales to be reviewed 350, the administrator (e.g. sales manager) logs-in to the incentive program website (see FIG. 3), selects “Sales Pending” option (step 351) and checks for new reported sales (step 352). The program compares the User Information Store 7 and System Information store 9 data to determine if new sales exist. If no new sales exist 353, the administrator is presented with a No New Sales screen (step 354). If there are new sales 356, a list of Pending Sales is displayed (step 357). The administrator selects a sale to review (step 358), whereupon the user data is retrieved (step 366) and information relating to the sale is displayed 38. The administrator may then add or edit user data and also determine whether the sale should be approved, denied, or held for further review 360. After action by the administrator, the program confirms the administrator's action and offers further selection options 363, such as review of another record. Next, the User Information Store 7 is updated and email notice is sent User (e.g. sales representative) 365, relaying the nature of the action taken by the administrator 366 (e.g., “sales approved, 5 points awarded”).

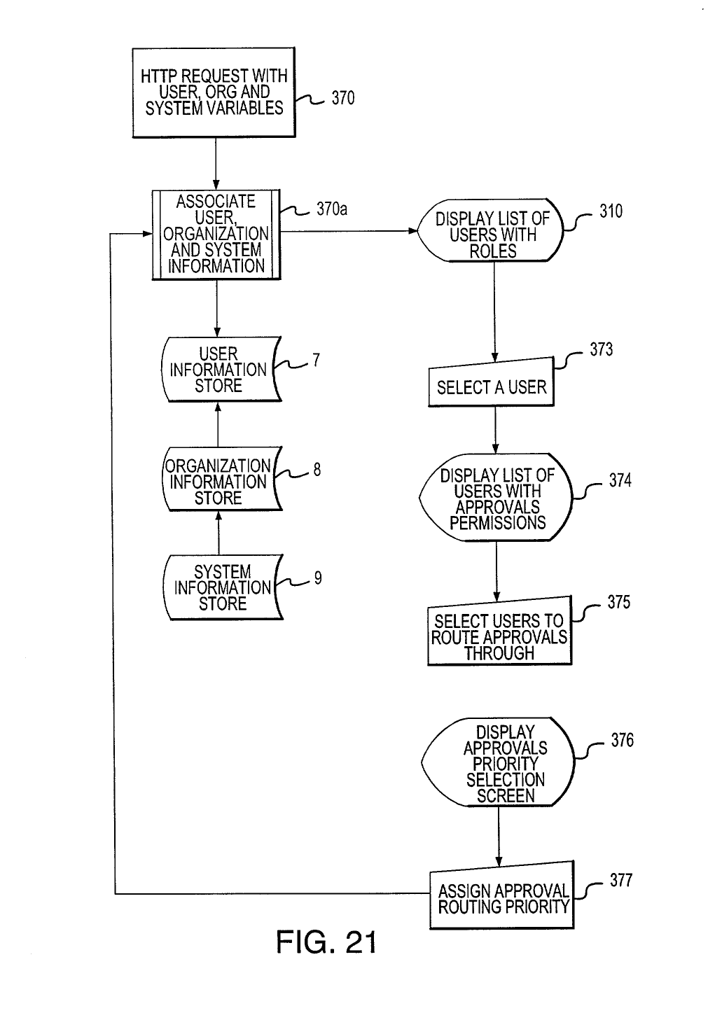

Additional exemplary sales reporting and approval systems may be employed by the present invention. FIG. 21 shows an exemplary system for designating Users with approval authority, where a list of Users with Roles are displayed. That is, all users and their identified roles are listed. For example, User A may have the designated role as a sales representative and User B may be defined as a sales manager. A ROLE is selected, e.g. manager, and a list of all Users with that Role (manager) permissions are displayed 374. The selection 375 is made as to who will have approval authority for a given file. The routing priority assigned to a file 377 is then selected from an Approval Priority selection screen 376.

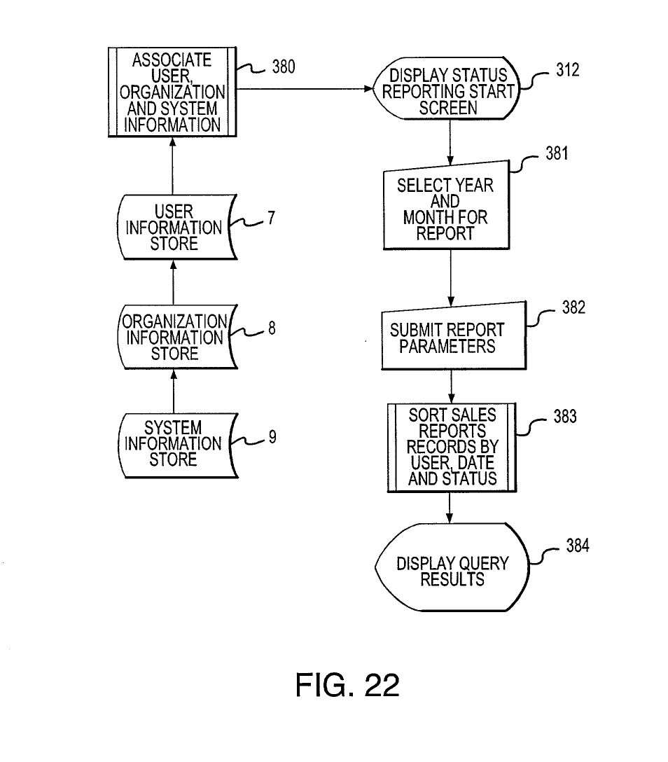

An exemplary system of the present invention for reporting the status of sales is shown in FIG. 22. A status reporting screen 312 may be selected from the main sales web page. A user may obtain sales reports (e.g., sale pending or sale approved) according to a variety of report parameters, e.g., selection of year and month 381. The report is submitted via the program and retrieved from the User Information 7, Organization 8, and System information 9 databases. These reports may then be sorted by, for example, user, date and status 383 and displayed 384.

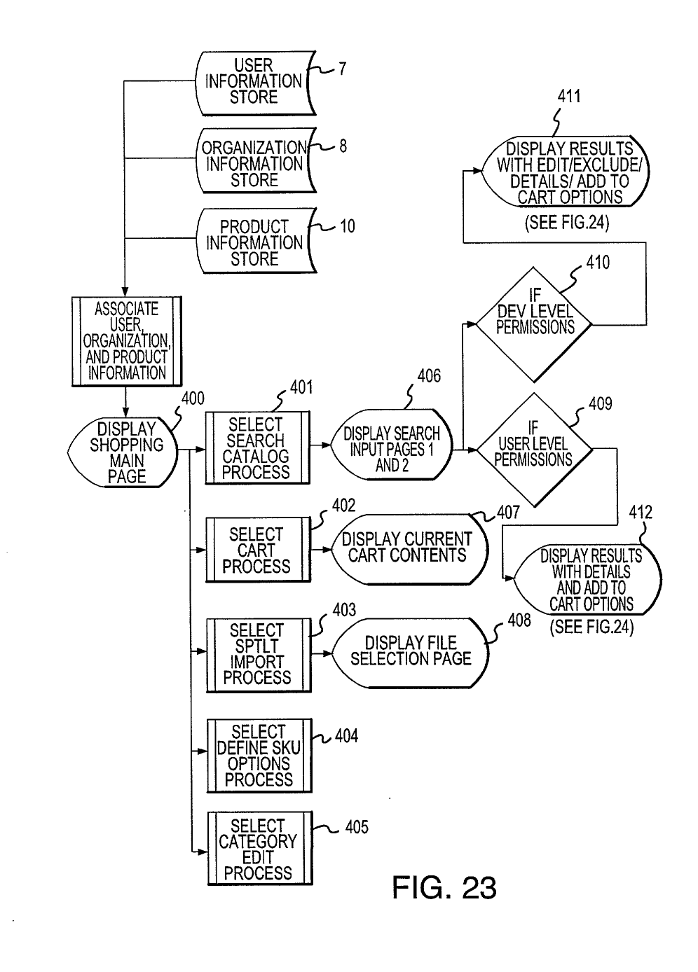

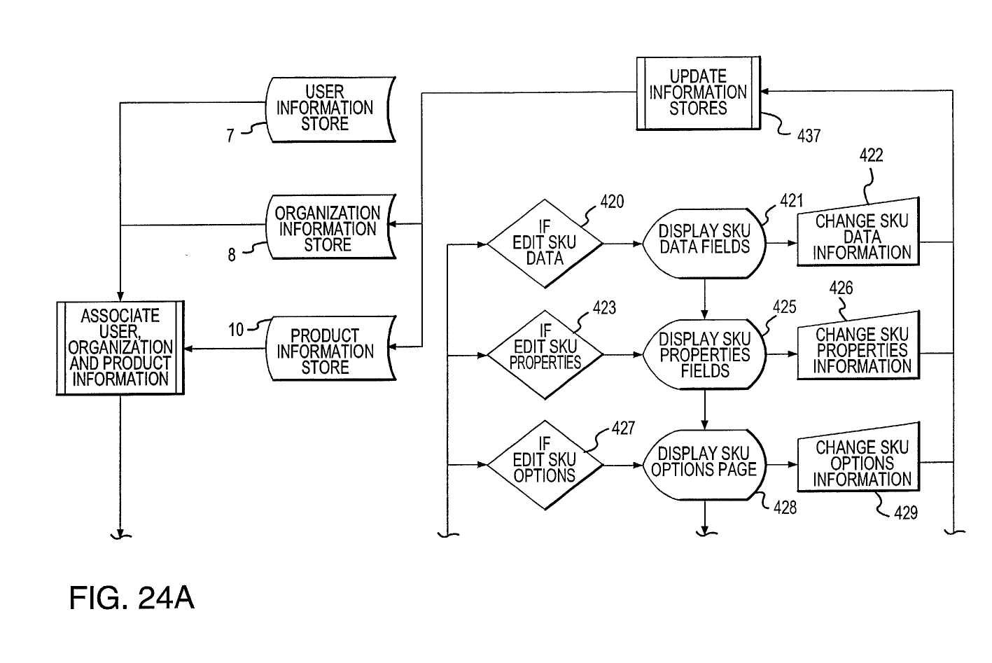

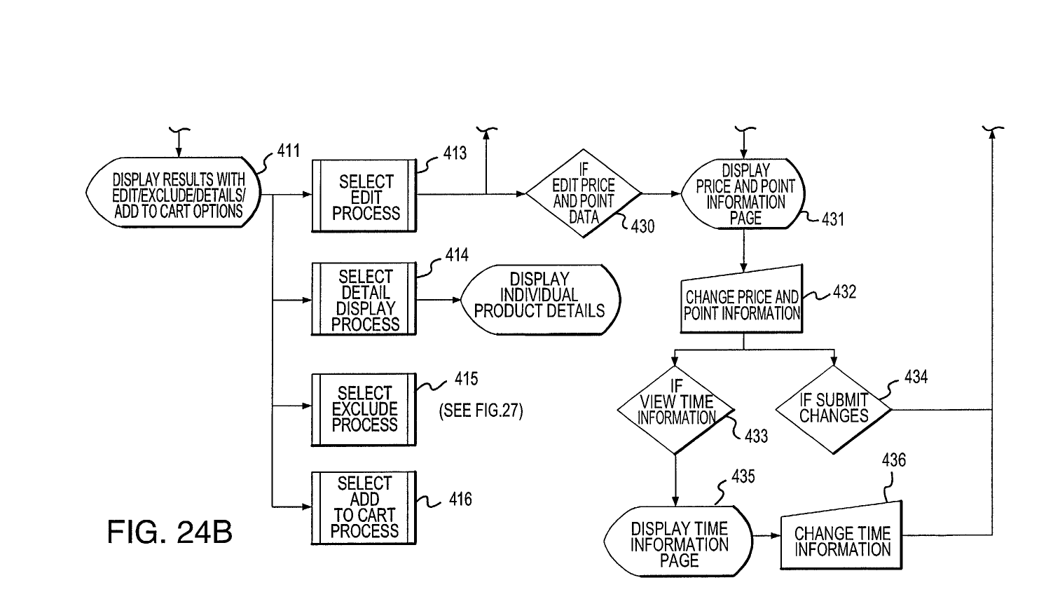

As the User sells product, and his or her sales are approved, the User accumulates incentive points that may be redeemed for rewards or prizes. The Incentive company may function as its own fulfillment company, the incentive company may engage other companies (or vendors) to assist as a fulfillment house or to provide merchandise, the subscriber may desire to fulfill product requests itself or the system my employ a combination of all three. FIGS. 23-27 depict an exemplary incentive marketing fulfillment system. FIG. 23 illustrates how the user, after accumulating incentive points, may turn to a shopping page 400 on the incentive company's website to redeem points for product. As shown in FIG. 23, a virtual catalog of merchandise or services is stored on at least one database (e.g., Product Information Store 10). The User may search the catalog 401 for merchandise or services by a number of different fields (e.g., type, product name, or SKU). Depending on the permissions level of the user, different products are retrieved and options presented to the User. For example, if the User is the program developer 410, his or her permissions will permit complete modification of fulfillment parameters (e.g., edit, exclude product, show details and add to cart) 411 (see FIG. 24). If the User, however, has basic user-level permissions (e.g., sales representative), the search results will be displayed showing product details and the Add to Shopping Cart options 412 (see FIG. 24). Other exemplary processes of the present invention shown in FIG. 23 are the (1) Select Cart 402 and review current shopping cart contents 407; (2) Select import process for importing merchandise data; (3) Select Define SKU options, and (4) Select Category Edit.

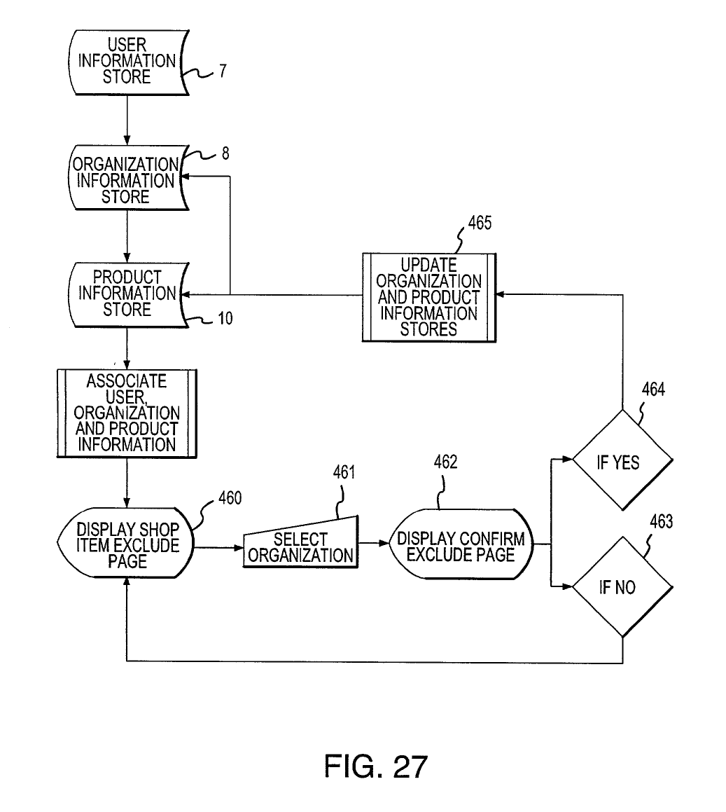

Referencing FIG. 24, several exemplary fulfillment processes are shown, specifically the Select Edit Process 413. As noted above, when a user selects a catalog search, results are displayed that, depending on User permissions, provide for a number of User operations. The User, depending on assigned permissions, may edit 413, get a detailed display of product 414, exclude product from catalog 415 (see FIG. 27) or add a product selection to the cart 416. As previously mentioned, the typical sales representative user would generally access the Detailed Description process (to get more information about a given product) or the Add To Cart process (selecting a product to purchase).

Another exemplary feature of the present system is the ability to adapt the catalog to changing real-world conditions, e.g., changes in product costs, incentive needs, etc. To accomplish this high degree of flexibility in modifying the fulfillment processes, some program users may be assigned permissions to edit the product catalog. The Edit process 413 shown in FIG. 24 depicts the steps for editing SKU (product identifiers) dates 420-22, editing SKU properties 423-26, editing SKU options, and editing price and point data 430-436. The edited SKU information is finally updated 437.

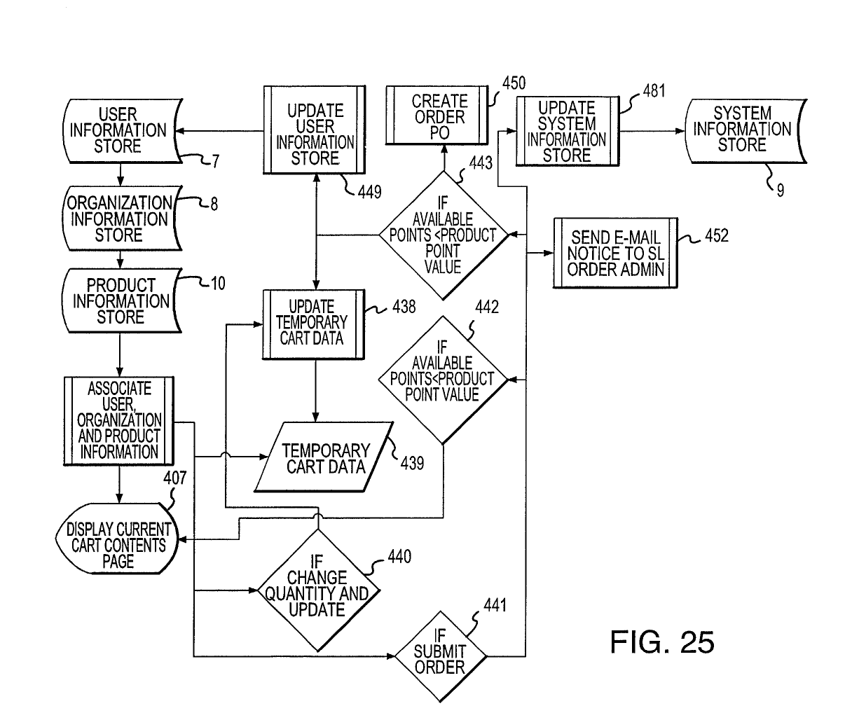

The selecting of reward prizes by redeeming incentive points is shown in FIG. 25. The User first selects the Current Cart Contents page (step 407) and submits order (step 441). If the User's available points is less than the product point value 442, the User is notified (step 452) and order processing does not continue. If available incentive points exceed the product point value 443, an order is created (step 450), at which point the System information Store 9 is updated (step 451). After order is redeemed the User Information Store is updated (step 449) and the Cart data is updated (step 438) and is temporarily stored (step 439) until all orders are finalized.

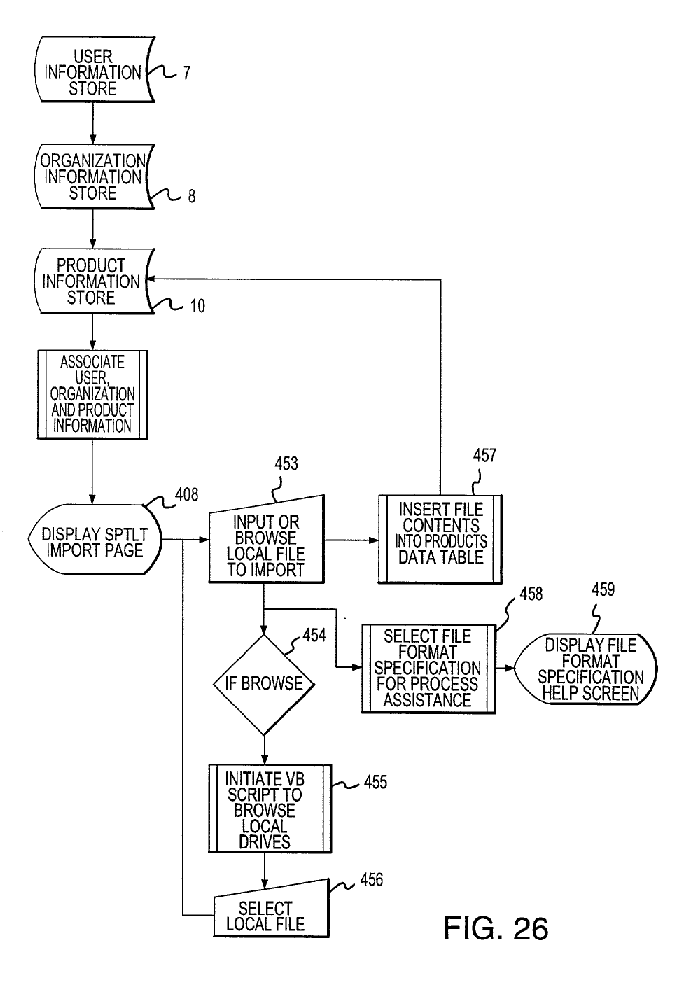

Another exemplary feature of the present invention is the ability to import data from external files to, for example, add merchandise to the merchandise catalog. FIG. 26 is a flowchart of an exemplary process for importing information, where the User links to the Import Page (step 408) and selects to input or browse file information (step 453). If file format specification is desired, the User may select file format (step 458), whereupon a help screen appears 459. If the User chooses to browse, the program initiates a local browse script to browse the local drives (step 455). Once the desired file is located, the file is selected (step 456) for importing. The User may choose to insert file contents (step 457) into the Product Information Store 10.

Another exemplary feature of the present invention is the ability of an authorized User to exclude products from the catalog. This process is accomplished, as shown in FIG. 27, by the User selecting the Item Exclude page (step 460), selecting the organization (step 461), select item to exclude, confirm exclude 462. If item is excluded (step 464), the Organization 8 and Product 10 Information stores are updated. If item is not excluded (step 463), the process is repeated.

What is claimed is:

1. A method for facilitating online incentive marketing and fulfillment transactions, comprising the following steps:
providing an incentive marketing program on a networked system;
receiving incentive marketing program requirements from Subscriber and modifying parameters of said incentive marketing program to develop a Subscriber-specific incentive marketing program;
registering at least one User to access said Subscriber-specific program according to pre-defined access parameters defined in said Subscriber-specific program;
logging-in to Subscribing-specific program with a password;
facilitating transactions between said Subscriber and said User by utilizing said networked system and said Subscriber-specific incentive marketing program;
receiving event transaction information;
awarding incentive points for approved event transaction information,
redeeming incentive points for a prize;
tracking and reporting said event transaction information;
communicating with said Users and said Subscribers to inform of Subscriber-specific program developments.

2. A method as recited in claim 1, wherein the networked system is the internet.

3. A method as recited in claim 2, comprising the step of designing the Subscriber-specific web site to take on the look and feel of the Subscriber's own web site.

4. A method as recited in claim 1, wherein the User registration step comprises the steps of:
receiving information from a new-User applicant for program access;
providing said applicant with a new-User form
receiving completed new-User form from said applicant;
processing said new-User form by comparing information on said new-User form with said Subscriber-specific program parameters.

5. A method as recited in claim 4, wherein if the Subscriber-specific program parameters provide for automatic registration, the method further comprises the step of automatically issuing program password to said applicant and assigning to applicant pre-defined program permissions.

6. A method as recited in claim 4, wherein if said Subscriber-specific program parameters do not provide for automatic registration, the method further comprises the following steps:
routing information from said new-user form to an approver who is authorized to approve, deny or hold registration;
receiving decision from said approver;
notifying said applicant of said decision.

7. A method as recited in claim 1, wherein if said password is correct, the method further comprises the step of directing said User to said Subscriber-specific program website.

8. A method as recited in claim 1, wherein if said password is incorrect, the method further comprises the step of directing said User to a generic-information website.

9. A method as recited in claim 1, further comprising the steps of
receiving event transaction information from said User;
comparing said event transaction information with parameters in the Subscriber-specific program to determine if event transaction information is automatically approved;
automatically awarding points to said User if said event transaction information is automatically approved.

10. A method as recited in claim 9, wherein if said event transaction information is not automatically approved, comprising the additional steps of:
routing said event transaction information to an event approver
receiving approve, deny or hold decision from approver

11. A method as recited in claim 9, wherein if event transaction information is approved, the method comprises the additional steps of:
awarding incentive points to said User; and
notifying said User of decision.

12. A method as recited in claim 10, wherein if event transaction information is not approved, the method comprises the additional step of notifying said User that said event transaction information was not approved.
